(19) United States
(12) Patent Application Publication
(10) Pub. No.: US 2015/0262129 A1
(43) Pub. Date: Sep. 17, 2015

(54) System and Method for Providing Information Regarding Persons Having Online Profiles

(71) Applicant: iValidate, Scottsdale, AZ (US)

(72) Inventors: Robert Maynard, Scottsdale, AZ (US); David Bradley Rust, Park City, UT (US); Kimberly M. Henning, Hingham, MA (US)

(21) Appl. No.: 14/645,332

(22) Filed: Mar. 11, 2015

Related U.S. Application Data
(60) Provisional application No. 61/951,210, filed on Mar. 11, 2014.

(51) Int. Cl. G06Q 10/10; G06Q 50/26; G06Q 50/00; G06Q 30/02

(52) U.S. Cl. CPC G06Q 10/10; G06Q 30/0269; G06Q 50/265; G06Q 50/01

(57) ABSTRACT

Embodiments of the invention include an online profile system for a user related to building and accessing an online profile and process a verification report of a first user. In some embodiments, the verification report can be distributed to an internet service interface based on the user's judgment of the accuracy, an administrator. In some embodiments, the verification report can be distributed based on a renewal date of the verification. In some embodiments, the online profile system can process dispute information from the first user, and initiate a secondary search of the first user to produce a verification report of the user. In some embodiments, the user can be verified using knowledge based questions including timed answers. In some further embodiments, the system can flag a user account of the first user for a deactivated or hidden profile. In some embodiments, the internet service interface includes an internet dating service.

### CROSS REFERENCE TO RELATED APPLICATIONS

This application claims the benefit of filing date of U.S. Provisional Application Ser. No. 61/951,210 titled “SYSTEM AND METHOD FOR PROVIDING INFORMATION REGARDING PERSONS HAVING ONLINE PROFILES” filed on Mar. 11, 2014, the specification of which is incorporated by reference herein in its entirety.

### BACKGROUND

As consumers continue to disintermediate third parties and conduct business or build relationships directly with other consumers, there has become a need to aggregate public and private information for compilation into a consumer background report.

Within today's interconnected society, many consumers of certain internet applications find they are faced with issues of fraud and violence. For example, in some cases, online dating users, crowd funding project managers and funders, or tradesmen, selected or contacted online, are victimized by individuals using synthetic identities. For instance, an individual who pursues match-making opportunities using internet dating websites often discover that the person they have been communicating with has a different name, gender, sexual preference, advertised personality, or is married. In other instances, homeowners who hire a contractor to conduct work in their home are sometimes victimized by criminals posing as such contractors. Further, in some circumstances, consumers using online listing sites such as Craig's list sometimes find themselves victims of crime because of the anonymous nature of the listing site.

Some internet companies conduct criminal background checks on behalf of their clients; however, these companies cannot be certain the customer is providing his or her real identity, and not a fictitious one. Accordingly, there is a need for a more robust system that verifies identity and other clients or consumer information using internet and other remotely operated businesses.

### SUMMARY

Some embodiments of the invention include an online profile system for a user comprising at least one processor configured to couple to at least one server and at least one non-transitory computer-readable storage medium for tangibly storing information related to a user account. The non-transitory computer-readable storage medium includes program logic related to building and accessing at least one online profile which when executed by the processor, can perform steps comprising using the at least one processor to process a verification of a first user. The steps also comprise receiving from the first user a user verification report distribution instruction based on the first user's judgment of the accuracy of the user verification report, where, based on the first user's judgment comprising an accurate judgment, the processor is configured to process steps: i). associate at least a portion of the first user's verification report with a first user's internet service profile within the internet service interface, and ii). send a user verification notification to the internet service interface that the first user has been verified, and iii). send a notification to the internet service interface to publish verification of identity to the first user's internet service profile, and iv). receive requests from the first user to send user verification results to a second user, and v). determine if the first user has completed verification processes, and vi). send notification to the internet service interface to send the first user verification report to the second user. Further, based on the at least one user's judgment comprising an inaccurate judgment, the processor is configured to provide the first user with an option to dispute at least a portion of the first user's verification report. The processor is also configured to receive and process dispute information from the first user, initiate a secondary search of the first user, and process a determination of the accuracy of the inaccurate judgment, notify the first user of results of the secondary search, and process steps (i) to (vi) based at least in part on the first user's agreement to publish the first user's verification report. Further, based on the first user's judgment comprising an accurate or inaccurate judgment, the processor is further configured to determine a renewal date of first user verification and send notification of the renewal date to the internet service interface

In some embodiments, the verification of the first user comprises performing a login process of the first user, using the at least one processor to electronically couple to an internet service interface. Further, the verification of the first user comprises providing a user verification process initiation tool wherein upon a first user selection of the tool the at least one processor is configured to perform a user verification of the first user comprising the steps of: receiving and processing by the at least one processor at least one verification question and creating at least one user verification report at least partially based on the at least one verification question, and providing the at least one user verification report to the first user.

In some embodiments of the invention, the user verification process initiation tool comprises an upsell offer. In some embodiments, the at least one verification question comprises at least one knowledge-based question and at least one demographic question. In some embodiments, responses from the at least one knowledge-based question are at least partially processed by the at least one processor to determine accuracy. In some embodiments of the invention, responses from the at least one demographic question are at least partially processed by the at least one processor to determine accuracy. In some further embodiments, responses from the at least one knowledge-based question are at least partially processed by a third party to determine accuracy. In some other embodiments, responses from the at least one demographic question are at least partially processed by a third party to determine accuracy.

In some embodiments of the invention, the verification of the first user comprises performing a login process of an administrator, using the at least one processor to electronically couple to an administrator interface. The verification of the first user comprises providing a user verification process initiation tool wherein upon the administrator selection of the tool the at least one processor is configured to perform a user verification of a first user comprising the steps of: confirming first user identity using at least one knowledge-based question, using a programming interface of a first social media application to verify a first type of personal first user information posted to the first social media application, using a programming interface of a second social media application to verify a second type of personal first user information posted to the second social media application, and providing the at least one user verification report to the first user.

In some embodiments, the at least one social media application is Facebook® and the first type of personal first user information comprises at least one photo of the first user. In some other embodiments, the at least one social media application is LinkedIn® and the second type of personal first user information comprises a first user's job history and title.

Some embodiments of the invention include an online profile system for a user comprising at least one processor configured to couple to at least one server and at least one non-transitory computer-readable storage medium for tangibly storing information related to a user account. The non-transitory computer-readable storage medium includes program logic related to building and accessing at least one online profile. When executed by the processor, the program logic can perform the steps comprising: using the at least one processor to process a verification of a first user, receive a first user verification report distribution instruction, associate at least a portion of the first user's verification report with a first user's internet service profile within the internet service interface, and send a user verification notification to the internet service interface that the first user has been verified. When executed by the processor, the program logic can also perform the steps comprising sending a notification to the internet service interface to publish verification of identity to the first user's internet service profile, receiving requests from the first user to send user verification results to a second user, determining if the first user has completed verification processes. When executed by the processor, the program logic can further perform the steps comprising send notification to the internet service interface to send the first user verification report to the second user, and determine a renewal date of first user verification and send notification of the renewal date to the internet service interface.

In some embodiments of the invention, the verification of the first user comprises performing a login process, using the at least one processor to electronically couple to an internet service interface. The verification of the first user include a providing a first user verification process initiation tool wherein upon a user selection of the tool the at least one processor is configured to perform a verification of the first user comprising the steps of receiving and processing by the at least one processor at least one verification question and creating at least one first user verification report at least partially based on the at least one verification question. The at least one verification question comprising at least one knowledge-based question and at least one demographic question, and providing the at least one user verification report to the user. In some embodiments, responses from the knowledge-based question are timed.

In some embodiments, the first user verification report distribution instruction is received from the first user. In some other embodiments, the first user verification report distribution instruction is received from an administrator. In some embodiments, responses from at least one of the at least one verification question are at least partially processed by the at least one processor to determine accuracy. In some embodiments of the invention, responses from at least one of the at least one verification question are at least partially processed by a third party to determine accuracy. Some embodiments include using the at least one processor to perform the steps of: flagging a user account of the first user upon receipt of a notification from the internet service interface that the user has a deactivated profile, the deactivated profile comprising at least one of an instance comprising the first user performing a profile deactivation, the first user performing a hide profile action, an administrator performing a profile deactivation, the at least one processor performing a profile deactivation based on notification from the internet service interface, and sending a notification to at least one of the first user, the internet service profile, and an administrator that the first user verification must be renewed.

Some embodiments include using the at least one processor to perform the steps of storing dates related to the verification of the first user including at least one of the date of initiation of the verification of the first user and the date the verification report was created, and sending notification of renewal of the verification of the first user to at least one of the user, the first user, and the internet service interface, and flag the verification of the first user as expired, and performing a verification of the first user based at least in part on receiving a request to renew the verification report within a specified time period.

In some embodiments of the invention, the internet service interface comprises an internet dating service.

### DESCRIPTION OF THE DRAWINGS

FIG. 1 is a block diagram of a system of providing information regarding persons having online profiles, in accordance with some embodiments of the invention.

FIG. 2 is a block diagram of a computer system that can be used for implementing the system and method of FIG. 1 configured in accordance with some embodiments of the invention.

FIG. 3 is a network diagram illustrating a network of computer systems that can be used for implementing the system and method of FIG. 1 configured in accordance with some embodiments of the invention.

FIGS. 4A and 4B illustrate block diagrams of the system and method of providing information regarding persons having online profiles in accordance with some embodiments of the invention.

FIG. 5 is a block diagram of the system and method of providing information regarding persons having online profiles in accordance with some embodiments of the invention.

FIG. 6 is a block diagram of the system and method of providing information regarding persons having online profiles in accordance with some embodiments of the invention.

FIG. 7 is a block diagram of the system and method of providing information regarding persons having online profiles in accordance with some embodiments of the invention.

FIG. 8 is a block diagram of the system and method of providing information regarding persons having online profiles in accordance with some embodiments of the invention.

FIG. 9 is a block diagram of the system and method of providing information regarding persons having online profiles in accordance with some embodiments of the invention.

FIG. 10A illustrates a knowledge-based authentication window used to verify the identity of the Internet user in accordance with some embodiments of the invention.

FIG. 10B illustrates a knowledge-based authentication window used to verify the identity of the Internet user in accordance with some embodiments of the invention.

FIG. 10C illustrates a knowledge-based authentication window used to verify the identity of the Internet user in accordance with some embodiments of the invention.

FIGS. 11A-E illustrate examples of knowledge-based authentication windows used to verify the identity of the Internet user in accordance with some embodiments of the invention.

FIG. 12 illustrates a knowledge-based authentication window used to verify the identity of the Internet user in accordance with some embodiments of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

It is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings. Further, “adapted for,” means configured, employed, implemented, or programmed, as well as any combination thereof, to carry out some process, function, step or routine.

The use of “administrator” or “agency” refers to an entity that is the administrator of the administrator interface, and verifies the identity of the user (or engages a third party to do so), as well as other user information, for an internet website displaying individual profiles, such as a dating website. Further, “administrator employee” means an individual or other entity, such as a business, that works for, or otherwise assists, the administrator in verifying identity of the user, as well as other user information for an internet website displaying individual profiles, such as a dating website. Further, the administrator employee, as used herein, can be an independent contractor and not necessarily an employee.

Throughout the description of the various embodiments of the invention described herein, references are made to “client” or “user” which refers to an individual or other entity that uses the inventive verification process to verify an online profile. The individual or other entity can include an individual or entity requiring an individual underwriting. The individual or other entity can include any individual or entity requiring verification of another user, individual, or entity. The online profile can include a dating profile, an individual or entity offering or selling merchandise or services. For example, the merchandise or services can include home care services (e.g., baby-sitting, pet sitting, house watching or minding), and/or can include an individual or entity offering home services (e.g., contractors, plumbers, pool service companies, etc.). In some embodiments, the “client” or “user” can be an e-commerce merchant, or any individual (such as a sole proprietor), group of individuals, and/or entity, and/or a plurality of entities.

The use of “computerized electronic server” or “electronic server” can refer to a website, web-enabled software, and/or any other electronic medium. Further, as used herein, “database” should be understood to cover reference to a single database or a collection of databases. Further, “electronic device” can refer to a computer (i.e., laptop or desktop), a mobile device, personal digital assistant, smart phone, digital television, internet protocol television, and/or play stations. Further, “in a computer or a mobile device” can refer to “operational in a computer or a mobile device.” It can also refer to any other configuration “in an electronic device,” such as any electronic device now known or later contemplated.

The use of “data messages” refers to data or information generated, sent, received or stored by electronic means. Further, “demographic questions” refers to questions such as, but not limited to, birthdate, residence information or history, age, birthplace, gender, criminal convictions or arrests, employment history or information, marital status, and the like. These “questions” can simply be in the form of, i.e., a request of marital status, or can be more detailed, i.e., requesting employment history for the last five years. Further, “internet website” is interchangeable with “website” and “internet.” It can also refer to any electronic medium capable of data transmission. Moreover, “internet website” can refer to a crowd-funding site, or the like. Further, “internet dating website” refers to an internet website having dating online profiles, wherein the user can communicate with one or more people associated with the dating profiles for e-dating or online dating. Further, “verification”, or any grammatical version thereof, refers to identity verification, as well as the determination of other personal information, such as marital status, criminal background check, credit check, pending legal civil and criminal cases, social media activity and the like. Further, a GUI (or simply, an “interface”) is a type of user interface that allows users to interact with programs in more ways than simply typing.

Throughout the description of the various embodiments of the invention described herein, references are made to the website or interface “updating” or any grammatical version thereof. This reference means that the system is taking note of the new information and updating one or more data variables within the system with the new information. For example, in some embodiments, new information can be received by the system, and the system can update the consumer account database, or any other database, with the new information. These “updates” can be triggered manually, automatically, and/or passively. As used herein, “manually,” or any grammatical version thereof, refers to one or more individuals interacting with the website to update information. For example, a user can input his or her information in order to verify identity. In some embodiments, an agency reviewing the information can be provided with a button to “update” or “refresh” the user's account to verify identity. Further, as used herein, “automatically,” or a grammatical version thereof, refers to a website updating. For example, in some embodiments, a website can automatically update a user account when a consumer is authenticated. In this instance, the website can “update” to reflect this status.

Some embodiments of the invention provide a system and method for providing information regarding persons having online profiles. The online profile can include an online profile of individual, a group of individuals, and/or an entity offering or selling merchandise or services. For example, the merchandise or services can include home care services, home maintenance or repair services, any service related to an article of manufacture owned or used by the user, or any medical or personal service required or desired by the user. Some embodiments of the invention provide information regarding persons having online dating profiles. In some embodiments, this can include online dating profiles posted and viewable within internet dating websites.

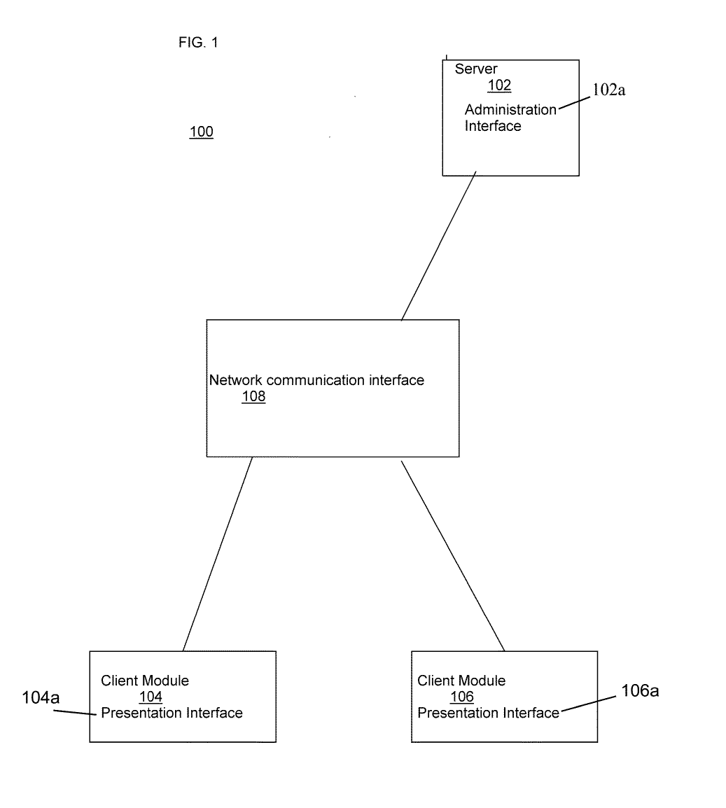

Some embodiments of the invention include a system and method facilitated by the use of a communications network such as an internet website accessible via a device capable of displaying an internet website such as a computer or processor, mobile device, or the like. In some embodiments, the internet website can display one or more graphical user interfaces (where “graphical user interface” is herein referred to as “GUI”). FIG. 1 is an example block diagram of a system 100 of providing information regarding persons having online profiles on dating websites.

In some embodiments, any one or both of the client modules can comprise a presentation interface, and in some embodiments, the presentation interface can comprise a GUI. In some embodiments, a user can review information displayed on the GUI for providing information regarding persons having online profiles. The user is generally able to access the GUI by entering a secure website on the internet, or any other electronic medium. In some embodiments, the GUI is displayed on an internet website accessible via a computer, or computer-enabled device. For example, in some embodiments, the GUI can be accessed by any web-enabled device, such as a computer or mobile device.

For example, in some embodiments, the client module 104 can comprise a presentation interface 104a. In some further embodiments, the client module 106 can comprise a presentation interface 106a). In some embodiments, the client modules 104 and 106 (each having presentation interfaces 104a, 106a respectively) can communicate with a server 102 (which in some embodiments includes administrative interface 102a) through the network communication interface 108. In some embodiments, the network communication interface 108 can comprise the internet. In some embodiments, the system 100 can include any number of client modules, including more or less than the client modules 104, 106 shown in the example embodiment of FIG. 1.

In some embodiments of the invention, the server 102 can comprise a computerized electronic server. In some embodiments, the server 102 can be encrypted. For example, in some embodiments, the server 102 can be encrypted using a Guardium® (“a registered trademark of IBM Corporation”) encryption product or any other application for file encryption or file sharing. In some other embodiments, the server 102 can communicate through a local area network or a cell phone network. In some embodiments of the invention, the server 102 can comprise a local area network or a cellular telephone network.

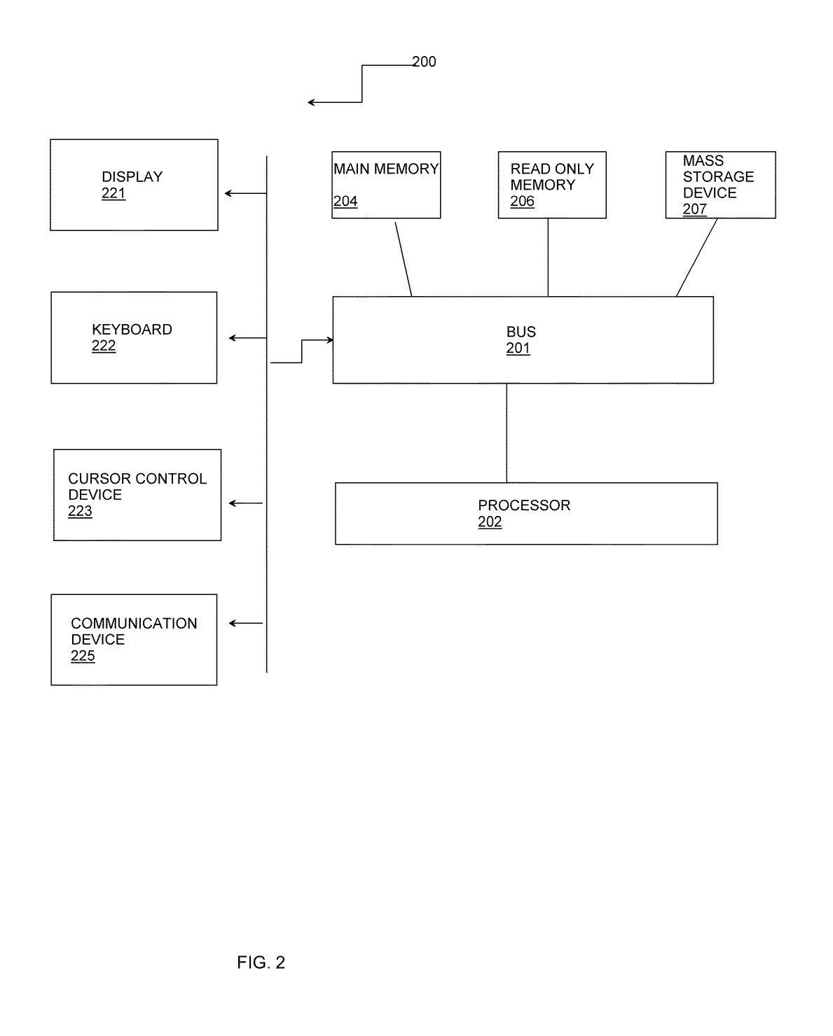

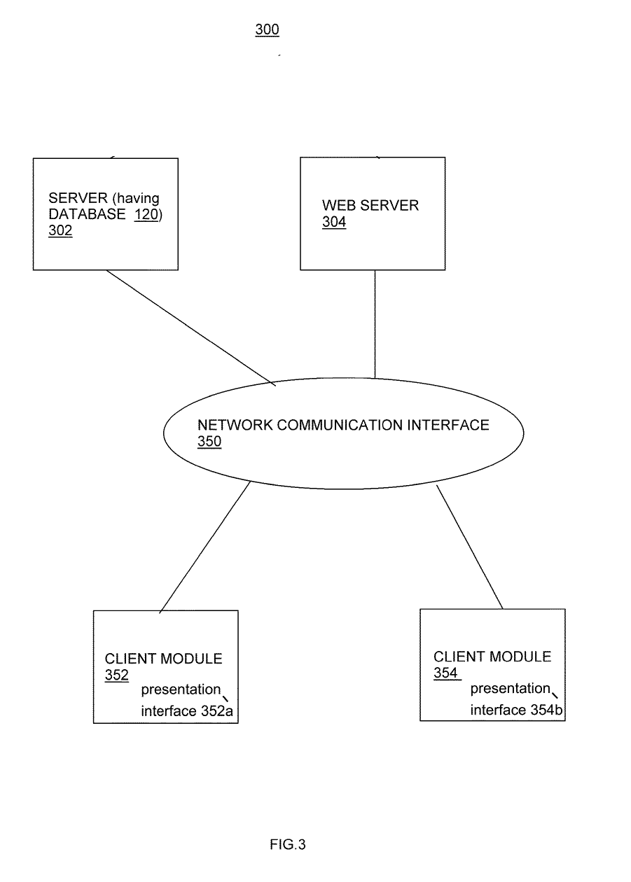

In some embodiments of the invention, the system 100 of providing information regarding persons having online profiles can be implemented using at least one computing system. For example, in some embodiments, any one of the methods of the system and method for providing information regarding persons having online profiles as described herein can be implemented using a system as illustrated, and can include at least one computing device, including at least one or more processors for performing at least one aspect of the method. In some embodiments of the invention, the system architecture can implement the system and method for providing information regarding persons having online profiles using one or more processors residing in one or more conventional server platforms. In some embodiments, the system architecture can include a network interface and an application interface coupled to at least one processors capable of running at least one operating system. Further, in some embodiments, the system architecture can include a network interface and an application interface coupled to at least one processor capable of running one or more of the software modules (e.g., enterprise applications). In some embodiments, the software modules can include server-based software platform that can include numerous other software modules suitable for hosting at least one account and at least one user account, as well as transferring data between one or more accounts. For example, FIG. 2 illustrates an example of a computer system 200 in which the features of some embodiments of the invention can be implemented. In some embodiments, the computer system 200 can include a bus 201 for communicating information between the components in the computer system 200. Further, in some embodiments, at least one processor 202 can be coupled with the bus 201 for executing software code or instructions relating to at least one feature and/or method of the invention. For example, in some embodiments, at least one processor 202 can process information regarding persons having online profiles on dating websites. In some embodiments, the computer system 200 can further comprise a main memory 204 capable of being accessed by the at least one processor through the bus 201. In some embodiments, the main memory 204 can be implemented using random access memory (RAM) and/or other random memory storage device. In some embodiments of the invention, the main memory 204 can be coupled to the bus 201 for storing information and instructions to be executed by the at least one processor 202. Further, in some embodiments, the main memory 204 can be used for storing temporary variables or other intermediate information during the execution of instructions by the at least one processor 202. In some embodiments, the computer system 200 can also include a read only (ROM) and/or other static storage device coupled to the bus 201 for storing static information and instructions for the at least one processor 202.

In some embodiments of the invention, the computer system 200 can include one or more peripheral components enabling user interaction with the system 200. For example, in some embodiments, the system 200 can include a cursor control device 223, such as a conventional mouse, touch mouse, trackball, track pad, or other type of cursor direction keys for communicating direction information and command selection to the processor 202, and for controlling movement of a cursor on the display 221. Various types of input devices, including, but not limited to the input devices described herein, can allow the user to provide command or input to the computer system 200. For example, in the various descriptions contained herein, reference can be made to the user “clicking,” “selecting”, or “inputting” and any other grammatical versions thereof, one or more items in a user interface (such as a GUI). Within the context of the disclosure, the user is using one or more input devices to accomplish the input when reference is made to the user “clicking,” “selecting”, or “inputting”, and the like. In some embodiments, the system 200 can also include at least one keyboard 222 for data input, and for facilitation of command and control of the various aspects of the system 200. Further, some embodiments include at least one communication device 225 operatively coupled to the processor 202 via the bus 201. Although not illustrated, the computer system 200 can optionally include video capability, one or more cameras, speakers, a sound card, and the like.

In accordance with at least one embodiment of the invention, FIG. 3 illustrates a computer network comprising a server system 300 having a database server 302 for storing a database 120. In some embodiments, the server system 300 can comprise a web server 304 that stores the instructions necessary to access and deliver information from, as well as store information into, the database 120. In some embodiments, the database 120 stores information in one or more related databases that are logically grouped by predetermined areas. For example, in some embodiments, these areas can be identity information, public records information, and the like. In some embodiments, the database can be on a virtual server. For example, in some embodiments, the database 120 can be on the cloud. In at least one embodiment of the invention, the system and methods of at least one embodiment of the invention can be accessible via a website through cloud computing (i.e., through one or more virtual servers). For example, in some embodiments, cloud computing can provide a secure server for a consumer, the agency, the user, and the like, web-enabled GUI access via a virtual server. In some embodiments, cloud computing can serve to store and operate all of the GUIs, software, and databases of the invention. In other embodiments of the invention, cloud computing cannot be used, or can only be partially used. In this instance, the server 302 cannot be a virtual server, but can be a physical computer having internet access. In other embodiments, information can be stored or arranged using a variety of data storage software and hardware techniques known to those of ordinary skill in the art of database programming, and can run on a variety of commercially available hardware platforms.

In some embodiments, the user can use a client computer such as a client module 352 and/or a client module 354 to access the server system 300 through a network communication interface (network 350). In some embodiments, the network 350 can comprise an internet network. In some embodiments, any one or both of the client modules 352, 354 can include a communication interface. In some embodiments, the communication interface can comprise a GUI. For example in some embodiments, the client module 352 can comprise a presentation interface 352a. In some further embodiments, the client module 354 can comprise a presentation interface 354a as shown. In some embodiments, the client modules 352 and 354 can communicate with the server 304 through the network communication interface 350. In some further embodiments, other systems, such as those belonging to a manufacturer, can also be coupled to the server system 300. In the illustrated embodiment shown in FIG. 3, the network 350 represents a variety of networks that can include one or more local area networks as well as wide area networks in some embodiments. In some embodiments, the functionality provided by the database server 302, web server 304, client modules 352, 354, their respective presentation interfaces 352a, 354b, as well as by the manufacturer, can be implemented using a computer system having the characteristics of the computer system 200 described herein and illustrated in FIG. 2. It should be noted, however, that in some embodiments, the specific implementation of the computer system 200 or systems used to describe the some embodiments of the invention is not to be limiting unless specifically noted. For example, the functionality provided by the database server 302 and the web server 304 can be offered by one computer system. Further, the functionality provided by the database server 302 and web server 304 can be redistributed over several computers in some other embodiments.

In some embodiments of the invention, the user (i.e., the consumer) can interact with the information stored in the database 120 through the GUI (e.g., through the presentation interfaces 104a, 106a). In some embodiments, the GUI (interfaces 104a, 106a) can be implemented using one or more web pages (which can be referred to herein as “pages,” “screens,” or “forms”) provided by the web server 304 accessible by the user using any internet web browser software. For example, some embodiments can include an internet web browser software such as Internet Explorer® web browser produced by Microsoft Corporation, Inc., operating on a client computer such as the client module 352 or other client device such as a mobile computing device and/or display. Internet Explorer® is a registered trademark of Microsoft Corporation in the United States and other countries.

Some embodiments of the invention are configured to support a non-GUI interface. For example, in some embodiments, a third-party can integrate with the system 100 and execute GUI components. In this instance, a user can interact with the system 100 through an API.

In another embodiment of the invention, one or more custom software programs can be created to implement the systems described herein. In some embodiments, the web server 304 can itself have browser software installed on it so as to be accessed by the user. Further, throughout the description of the various embodiments of the invention herein, references are made to the user performing such actions as selecting buttons or clicking on, executing searches or updates on the database 120. In some embodiments, these requests can be generated by the user interacting with the aforementioned browser.

In some embodiments, the one or more web pages described herein can include a form interface (e.g., a drop down menu, a radio button selection, etc.). In some embodiments, once the user has provided such a selection, the user can select a button or a link on the web page to request an update of the database 120 with the information. In this instance, the browser can send the web server 304 a link that includes the information (i.e., the user's selection) being sent as well as a request to update the database 120.

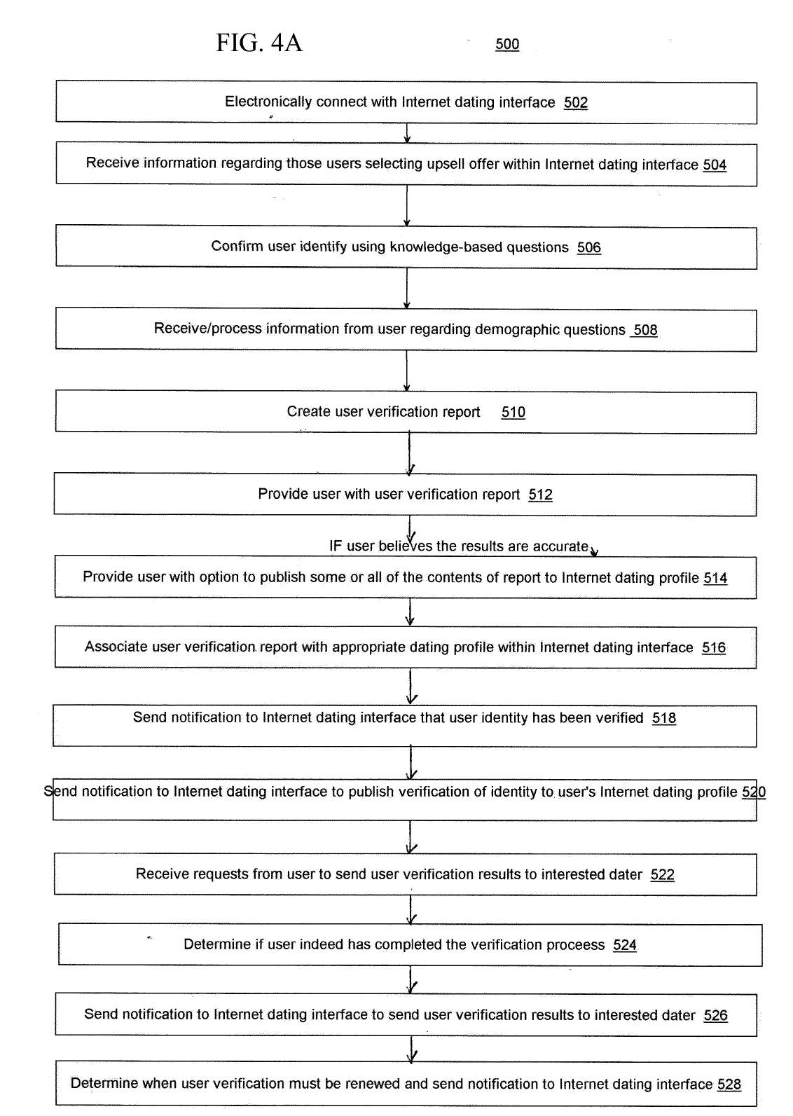

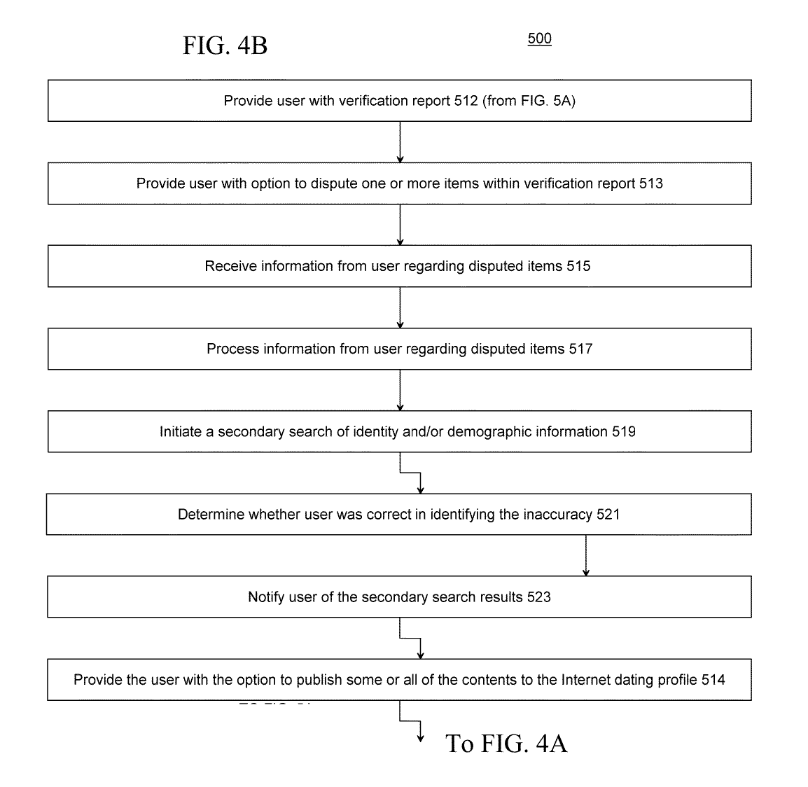

In some embodiments, the system 100 and/or the system 300 can include a system and method for verifying identity and other personal information for online profiles. For example, in at least one embodiment, an example online profile can be an internet dating profile. It is to be understood, however, that embodiments of the invention described herein are not limited to dating profiles, and that in some embodiments, the system and methods described herein can be used to verify other online profiles, such as nanny profiles, or any online profiles related to individuals, groups of individuals, or entities providing any of product or service as described earlier. In the following description, the invention can be described by a series of example processes including steps as shown in FIGS. 4A-4B, and FIGS. 5-9. In some embodiments, these steps can be configured to be processed using the system 100 and/or system 300. Further, it is to be understood that the invention is not limited to these steps, and one or more of the steps can be omitted, replaced, and/or conducted in a different order without departing from the scope of some embodiments of the invention.

Referring to FIG. 4A, some embodiments of the invention can comprise the system 500 comprising a plurality of steps that can be processed by the system 500 to provide information regarding online profiles. For example, in some embodiments, the system 500 can include one or more steps processed by the computer system 200 to provide information regarding online profiles. In some embodiments, a user may or may not already have an online dating profile. For example, in some embodiments, if the user has never logged onto an internet dating service's website, the user can be directed to register with the internet dating service operator or service provider (within the internet dating interface). In some embodiments, if the user has already registered with the internet dating service, the user can be directed to log into the service. In some embodiments of the invention, to log into the service and/or any of the embodiments described herein, a user can enter or input a valid username and password into respective username (or email) and password fields. In some embodiments, upon entering a username and password, the user can then select a login button to proceed. Thereafter, in some embodiments, the user can be directed to build his or her internet dating profile.

In some embodiments of the invention, the system 500, via a log-in screen, can provide a link if the user forgets his or her username and/or password. In a first step 502 shown in FIG. 4A, the system 500 can electronically couple with the internet dating interface. In some embodiments, the system 500 can be configured to receive information regarding those users selecting the upsell offer within the internet dating interface (step 504). In some embodiments, this information can include, but is not limited to, profile handle name (within the internet dating interface); the name the user registered with (within internet dating interface); residence address information; age; birth date; and the like. In some embodiments, during the process of building the internet dating profile, or anytime thereafter, the user can be provided with a feature or tool such as a “verification” tab or button (or an “upsell” offer within the dating interface) to initiate the verification process described herein. In some embodiments, upon selecting this tool or feature, the user can be directed to the presentation interface or user verification interface. For example, in some embodiments, the user can be directed to the presentation interface 352a, 354b. In other embodiments, the user can be directed to the presentation interface 104a, 106a. In some embodiments, the user verification interface can comprise one or more steps for verifying a user, and those steps can include one or more processes that comprise interaction through a GUI, that can comprise any presentation interface 104a, 106a, 352a, 354b in some embodiments. In this instance, in some embodiments, the user can leave the internet dating website. In some further embodiments, upon entering the presentation interface 104a, 106a, 352a, 354b, the user can be directed to log-in again, and the user can log-in with another username and password, or not log-in at all (and continue with the verification process without logging in). In other embodiments, the presentation interface can be available within the internet dating interface itself (i.e., the user does not have to “leave” the internet dating interface to initiate the verification process described herein).

In some embodiments of the invention, the user verification interface can be separate from the internet dating interface. In some embodiments, the user verification interface can be accessible via the internet dating website via a link or a selection of a “verification” tab or button (or an “upsell” offer) as described above. In some embodiments, the user verification GUI can provide the consumer with a number of options to select. For example, in some embodiments, the user can be provided with (or the website can be configured with) a “help” feature or tool in the form of a drop down menu of topics, or the like. In some embodiments, the “help” feature can include a live chat service (to assist in the verification process). In other embodiments, the user verification interface can be a part of the internet dating website, or cannot be accessible via the internet dating website.

In some embodiments, the user can be provided with a tool or feature (i.e., a fillable, online form on the user verification interface) to provide additional identifying information. In some embodiments, user information collected from the internet dating website, and can be used to populate certain user information fields within the user verification interface. In some embodiments, additional information can be needed. For example, in some embodiments, the user can be asked to provide his or her Social Security number so that a credit report can be retrieved by the agency/administrator. Additionally, in some embodiments, the user can be asked to provide employment status, Social Security number, marital status, criminal convictions or arrests, pending civil suits, current restraining orders, whether he or she is a registered sex offender and/or child abuser, and the like. In some embodiments, the user can be provided the option of providing only certain information. In some further embodiments, the user identifying information can be located in a user database within the server (e.g., user database 120 within server 302).

In some embodiments, the user can update his or her account information at any time. In some embodiments, updating user information within the internet dating interface automatically updates corresponding user information within the user verification or presentation interface. Additionally, in some embodiments, the user can be provided with a tool or feature, such as a drop down menu, radial button selection, or the like, to select the type or level of verification service he or she would like. In some embodiments, types or levels of verification service can be, but are not limited to, verification of identity, verification of identity and marital status, verification of identity and employment status, verification of identity and criminal background check, and the like. In some embodiments, the user's identify is verified prior to determining other parameters, such as marital status or criminal convictions. In other embodiments, the user is not provided with the option of deciding what type or level of verification service he or she would like (and can have to simply proceed with the “standard” verification service).

In some embodiments, in order to confirm the user's identity, knowledge-based authentication (“KBA”) can be used. In this regard, the user can be prompted within the user verification interface to answer whether he or she would like to begin the identity verification process. In some embodiments, if the user chooses to proceed, then the user can be asked a series of questions based upon the user's credit report, public records, or the like. In some embodiments, the agency interface is different from the user/presentation interface 104a, 106a. In some other embodiments, the administrator interface 102a is not accessible via an internet dating website. Moreover, in some embodiments, access to the administrator interface 102a (or its contents) can be restricted to protect user privacy.

Some embodiments of the invention include an administrator registration. In some embodiments, the administrator's registration process can require some level of authentication. In some embodiments, if the administrator has already registered, the administrator can log-in (e.g., through the administration interface 102a). To log-in, the administrator can enter a valid username and password into the respective username (or email) and password fields. In some embodiments, the log-in screen can provide a link for the administrator if the administrator forgets his or her username or password. In some embodiments, upon entering a username and password, the administrator can then select a login button to proceed. In some embodiments, the administrative interface 102a can thereby identify the user as an administrator, and not a user. As such, in some embodiments, an administrator homepage and/or administrative interface can be displayed upon log-in. In some embodiments, the administrative interface is a secure website that is only accessible by authorized individuals. In some other embodiments, the administrator can use other methods of authentication in lieu of, or in connection with, entering a username/password. For example, in some embodiments, the agency employee can be asked a series of questions, and/or asked to swipe a card, or the like, for authentication purposes in lieu of, or in addition to, logging in.

In some embodiments of the invention, the administrator homepage can provide the administrator with a number of tools or features that can differ depending on the type of administrator (and the level of access allowed). For example, in some embodiments, the administrator can be provided with a tool (such as a link or button on the administrative interface/website) which allows access to user accounts and/or the user account database, and/or a tool that allows the administrator to electronically communicate with the user via data messages. In some embodiments, the administrator can be provided with a feature or a tool on the administrator website to identify user accounts that are “pending.” In some embodiments, “pending” accounts can be noted or otherwise flagged in the system. In some embodiments, “pending” accounts are those user accounts that have not been reviewed by the agency, or are in the process of being reviewed by the administrator.

In some embodiments, once a user's identity is verified, the administrator can be enabled to send an email or a data message to the user informing him or her of the same. In some embodiments, the email can be sent to the user's personal email address, and/or the user's inbox on the dating website. The user, in turn, can be provided with a tool or feature to publish the identity verification to his or her profile. In some embodiments, after identify verification, the administrator can be provided with a feature a tool to determine other personal information regarding the particular user. These tools or features can be available directly on the administrative interface, or a link to these tools or features can be available directly on the administrator interface 102a. For example, a public records function can be available directly on the administrator interface 102a. Further, in some embodiments, the administrator can be available to determine the criminal history of the user; employment status; marital status; citizenship and/or residency status (i.e., whether the user is a U.S. citizen or not, holds a valid, and unexpired U.S. visa, or is a green card holder); civil suits against the user; whether the user is a registered sex offender or a child abuser; whether the user is a homeowner, and the like. In other embodiments, the administrator can have a partner entity conduct the public records search of its users.

In some embodiments, the user can log in to the user verification interface and retrieve the results. Thereafter, in some embodiments, the user can have an unlimited time to review, accept, or dispute the results, or can have a set period of time to review the results, accept or dispute them, after which the results expire, and a new verification process needs to be initiated. In some embodiments, should the user accept the results, the administrator can be notified. In some embodiments, notification can be in the form of an email, data message, or a “flag” on the particular user's account within the system itself In some embodiments, this notification can include information as to whether the user would like to publish his or her results to her internet dating profile, and, if so, what would he or she like published.

The verification results can be published to the user internet dating profile in a number of different ways. For example, in some embodiments, the administrator can send a data message or other electronic communication to the entity operating the internet dating website. The entity can then publish information to indicate that the user's identity has been verified, and that certain aspects of his or her personal information have been determined. In some embodiments, this can be in the form of a word or slogan, such as “verified,” “checkmated,” or the like.

In other embodiments, the administrator can be provided with a feature or tool to publish the verification to the particular user's profile through the administrator interface 102a. In other embodiments, the user can be provided with a tool or feature (such as a “publish” button or tab on the user verification interface) to publish the results to his or her profile. In some embodiments, selecting this tool or feature can prompt the internet dating website itself to publish the results.

In some embodiments of the invention, the administrator can be provided with a feature or tool on the administrator interface 102a to identify user accounts that need “renewal,” (i.e., that need to be re-verified). For example, in some embodiments, the time period for verification can expire after one year (or any other set time period). In this instance, in some embodiments, the user can be sent an email reminding him or her of the impending expiration. In some embodiments, if the user chooses to do so, he or she can respond to the email and request re-verification. In some embodiments, the administrator can re-verify the user with a process substantially similar to that described above, or an abbreviated process (i.e., a process wherein user identity does not need to be determined again).

In some embodiments, a user's verification can be set to expire (e.g., a year or any other time period) from when it was initiated. In some embodiments, if the user's verification was published to his or her online dating profile, then the publication can notify the public of its expiration (i.e., with the word “expired” on the publication itself). In some embodiments, the publication can be removed by the administrator. Additionally, in some embodiments, if a user decides to “hide” a profile (for example in instances where the user thinks he or she has found someone, but decides to “re-activate” it at a later date), the user can be prompted to begin the verification process again. In some embodiments of the invention, the administrator can be provided with a feature or tool (such as knowledge-based authentication) to verify the identity of a user. In this regard, the administrator can be provided with a list of links or options on or within the administrative interface 102a to verify a user's identity (such as address records, credit reports, and the like).

Referring again to FIG. 4A, in some embodiments of the invention, the administrative interface 102a can be configured to receive user answers from the knowledge-based authentication questions (see step 506). In some embodiments, once the user has entered his or her information and/or answered KBA questions, he or she can be provided with a feature or tool to submit the information to the agency, such as a “submit” button within the user verification interface. For example, in some embodiments, the system 500 (i.e., operating through administrator interface 102a) can be configured to confirm a user's identity using knowledge-based questions available within the administrator interface 102a. In some further embodiments, the system 500 can be configured to receive and process information from the user regarding demographic questions (step 508). In this instance, the system 500 can be configured to receive and process information from the internet dating interface and/or the user. In some further embodiments, the system 500 can include the process of information gathering comprising confirming/checking user demographic information, such as marital status, using third party sources and/or research.

Some embodiments of the invention can comprise a step 510 in which the system 500 can be configured to create a user verification report. In some embodiments, the user verification report includes a verification of identity as well as user demographic information (i.e., marital status, employment status, criminal history, civil litigation history, and the like). In some embodiments, the system 500 can be configured to provide the user with a verification report (step 512).

The user can receive the results of the verification in a number of ways. For example, in some embodiments, he or she can receive an email (in the user's personal email account in some embodiments) from the agency having the results of the verification and/or a link to view the results. In some embodiments, the user can be asked to review and “accept” the results. In some embodiments, if the user agrees with the results of the verification, then he or she “accept” the results by clicking on an “accept” button. In some further embodiments, if the user disputes one or more results of his or her verification, he or she can be provided with a tool or feature to dispute one or more of the results. For example, in some embodiments, the user can be able to send an email to the agency regarding what is disputed, and the reason(s) why, or can be provided with a “dispute” button on the user verification interface. In some embodiments of the invention, if the user believes the verification report is accurate, the system 500 can be configured to provide the user with the option to publish some or all of the contents of the report to his or her internet dating profile. In some embodiments, if the user does not believe the verification report is accurate, the system 500 can be configured to provide the user with the option to contest the results, as shown in FIG. 4B and discussed further below.

In some embodiments of the invention, the user can be provided with a tool or feature to publish and make public the results of the verification, such as a “publish” tab, button, or link, on the user verification interface (or on the internet dating website interface itself). In some embodiments, the user can choose to publish the results of his or her verification to his or her internet dating profile. In some embodiments of the invention, the user can be provided with an option of choosing to publish at any time during the process of verification and/or any time his or her dating profile is live. For example, in some embodiments, the user can be provided with the option of publishing the results of the verification once he or she receives the results and reviews them for accuracy (step 514). In some embodiments, the user can select what information he or she wants published to his or her dating profile. In this regard, the user can decide to publish the fact that his or her identity was “verified;” his or her marital status; his or her criminal background information, and the like. The user can also decide to publish his or her credit score to his or her profile. In other embodiments, the user can only have the choice of deciding whether to publish or not, not the contents of the publication itself.

In some embodiments, as shown in step 516, the system 500 can be configured to associate a user verification report with appropriate dating profile within internet dating interface. In this instance, the system 500 can be configured to associate the user verification report with the appropriate profile handle within the internet dating interface. In some embodiments, once this is complete, the system 500 can be configured to send notification (i.e., electronic notification) to the internet dating interface that user identity has been verified and that one or more demographic parameters have been verified or confirmed (step 518). In some embodiments, the system 500 can be configured to send notification (e.g., an electronic notification) to the internet dating interface to publish verification of identity and/or other selected demographic features to the user's internet dating profile (step 520).

Some embodiments of the invention include enabling the user to receive requests by others within the online dating community to “see” his or her verification report details (within the internet dating interface). For example, a woman who has been speaking with a user can ask to review his verification report. At this point, the user may or may not be inclined to provide the woman with his report. If the user chooses to provide the report, the user can be provided with the ability to provide the report to the woman. For example, the system 500 can be configured to receive requests from the user to send user verification results to one or more interested daters (step 522). In some other embodiments, the system 500 can be configured to determine if the user has indeed completed the verification process (step 524). In some embodiments, this step can be done at any time in the process, or at more than one time. In some embodiments, the system 500 can be configured to send notification to internet dating interface to send user verification results one or more interested daters (step 526). Further, in some embodiments of the invention, the system 500 can be configured to determine when user verification must be renewed, and to send notification to the internet dating interface regarding the same (step 528).

In other embodiments, one or more of the foregoing steps can be eliminated and/or replaced with other steps. For example, as described earlier, in some embodiments, if the user does not believe the verification report is accurate, the system can be configured to provide the user with the option to contest the results, as illustrated in FIG. 4B, where a user can be provided with a verification report in step 512. In some embodiments, the system can be configured to provide the option of disputing one or more items within the verification report (step 513). In some embodiments, the system 500 can be configured to receive information from a user regarding one or more disputed item (step 515). Thereafter, in some embodiments, the system 500 can be configured to process information from the user regarding one or more disputed items (step 517). For example, as shown in step 519, in some embodiments, the system 500 can be configured to initiate a secondary search of identity and/or demographic information. In some embodiments, the system 500 can be configured to determine whether the user was correct in identifying the supposed inaccuracy (step 521). Thereafter, in some embodiments, the user can be notified of the secondary search results (step 523). Further, in some embodiments, the user can be provided with the option of publishing some or all of the contents to his or her dating profile (shows as proceeding to step 514, where the system 500 would continue back to the steps in FIG. 4A as described earlier with respect to the steps 516, 518, 520, 522, 524, 526, and 528).

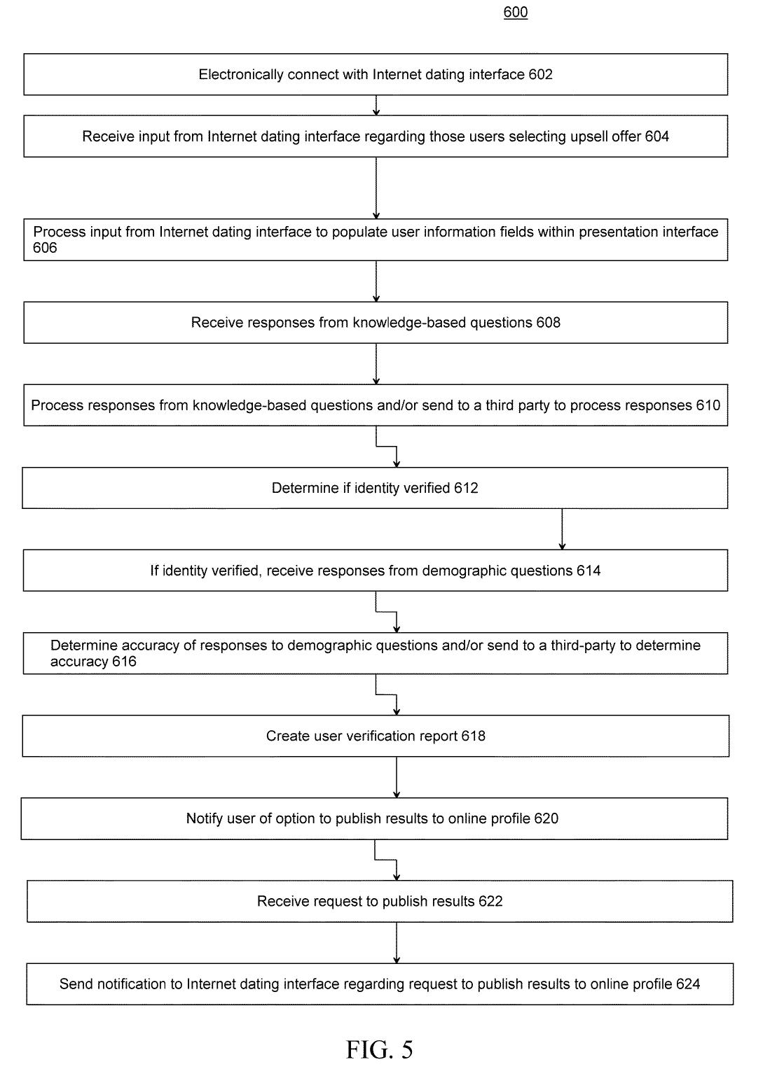

In some other embodiments of the invention, the verification of the user's identity can be performed by a third party. Referring to FIG. 5, in some embodiments, the system 100 can be configured to perform all or some of the following steps (as illustrated in the flowchart “600”, illustrating a plurality of steps performed by the system 100). For example, in some embodiments, the administrator interface 102a can be electronically coupled with at least one of the presentation interfaces 104a, 106a and/or an internet dating interface, in step 602. In some embodiments of the invention, in step 604, the system can be configured to receive input from the dating interface regarding those users selecting an upsell offer. In some embodiments, this information can include user name, user profile handle name, the date the user registered with the dating website and created his or her online profile, and/or any previous dates the user created an online profile with the dating service. Subsequently, in some embodiments, the system 100 can be configured to process input from the dating interface to populate user information fields within the presentation interface (shown as step 606). For example, in some embodiments, the system 100 can be configured to process user name, user address, the user's age, and the like, and input that information into the presentation interface 104a, 106a automatically so the user does not need to do this. In some embodiments, step 608 can include the system 100 configured to receive responses from knowledge-based questions. In some embodiments, the system 100 can be configured to process responses from knowledge-based questions and/or send to a third party to process responses (within step 610). Thereafter, in some embodiments, the system can be configured to determine if identity is indeed verified (in step 612). In this regard, the system 100 can be configured to determine if the person listed as a registrant within the dating interface is actually that person, or a fabricated name and/or a false identify. In some embodiments, if the person identity is verified, the system 100 can be configured to receive user responses to demographic questions (if any) in step 614. In some embodiments, in the subsequent step 616, the system 100 configured to determine the accuracy of responses to the demographic questions, and/or the system 100 is configured to send user responses to demographic questions to a third party to analyze. In some embodiments, once user demographic information is determined/confirmed/verified, the system 100 can be configured to prepare a user verification report (see step 618). Thereafter, in some embodiments, the system 100 can be configured to send notification to user that publication of identity verification and/or demographic information is available (shown a step 620). In some embodiments, this notification can include an outline of what information is available to publish (determined by, for example, whether the user requested the information to be verified, and whether the information was actually verified). In some embodiments, with a subsequent step 622, the system 100 can be configured to receive a user request to publish the results. In some embodiments, if the user wishes to publish the results to his or her online profile, the system 100 can be configured to send notification to the internet dating interface to publish some or all of the results (see step 624). In some embodiments, this notification can include information that the user would like to have published, and can omit information that the user would not like to publish.

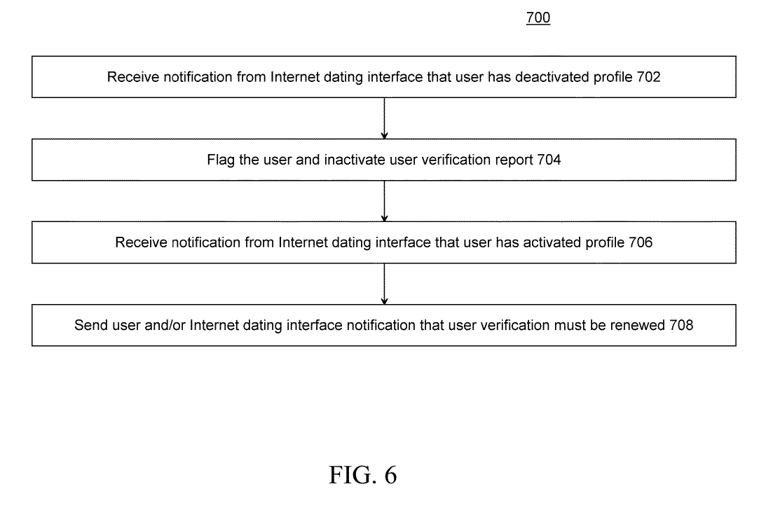

FIG. 6 is an example block diagram 700 illustrating steps of a method for processing when a user (who has used the subject verification system in the past) deactivates, and/or “hides” his or her profile. For example, in some embodiments, a step 702 can include the system 100 (e.g., through the administrator interface 102a) configured to receive notification from the dating interface that the user has deactivated and/or hidden his or her profile. As shown in step 704, in some embodiments, the system can “flag” or otherwise note the deactivation in the user account database 120 (within the server 302). In this instance, in some embodiments, the user verification report is inactivated. This is to prevent publication of outdated results should the user decide to have his or her profile “go live” again. Thereafter, in some embodiments, step 706 includes the user activating and/or un-hiding his or her profile. In this instance, the system 100 can then receive notification from the internet dating interface that the user has activated his or her profile. In some embodiments, the user account information can be flagged or otherwise noted to reflect the same. In some embodiments, the system 100 can be configured to send the user and/or the internet dating interface a notification that the user verification must be renewed (step 708).

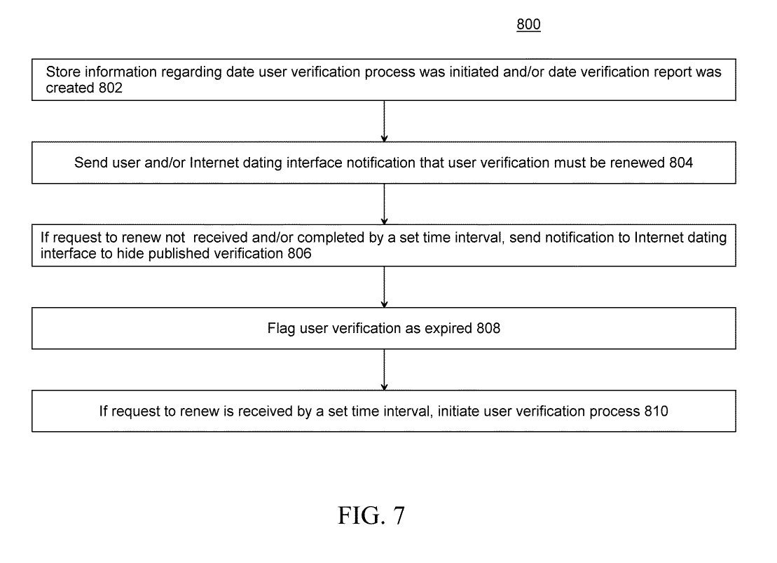

FIG. 7 illustrates an example block diagram 800 showing steps of a method to initiate the user verification renewal process (in instances where the user has not deactivated and/or hidden his or her profile). As shown in step 802, in some embodiments, the system 100 (e.g., through the administrator interface 102a) can be configured to store information regarding the date the user verification process was initiated and/or date the user verification report was created. In some embodiments, the user verification reports are only valid (and available for publication onto the user's online profile) for a set period of time (i.e., one year). In some embodiments, once the set period of time has expired (or will expire shortly, i.e., in a month) for that particular user, in some embodiments, the system 100 can be configured to send the user and/or the internet dating interface notification that the user verification must be renewed (step 804). In some embodiments, if the request to renew is not received and/or completed by a set time interval, then the system 100 can be configured to send notification to the dating interface to hide or remove publication of the user verification (step 806). Further, in some embodiments, step 808 can include the system 100 being configured to flag or otherwise note in the database that the user verification has expired (which can be done prior to, or simultaneous with, the previous step 806). On the other hand, if a request to renew is received and/or renewal is completed by a set time interval, then in some embodiments, the system 100 can be configured to initiate the user verification process (again) in a subsequent step 810.

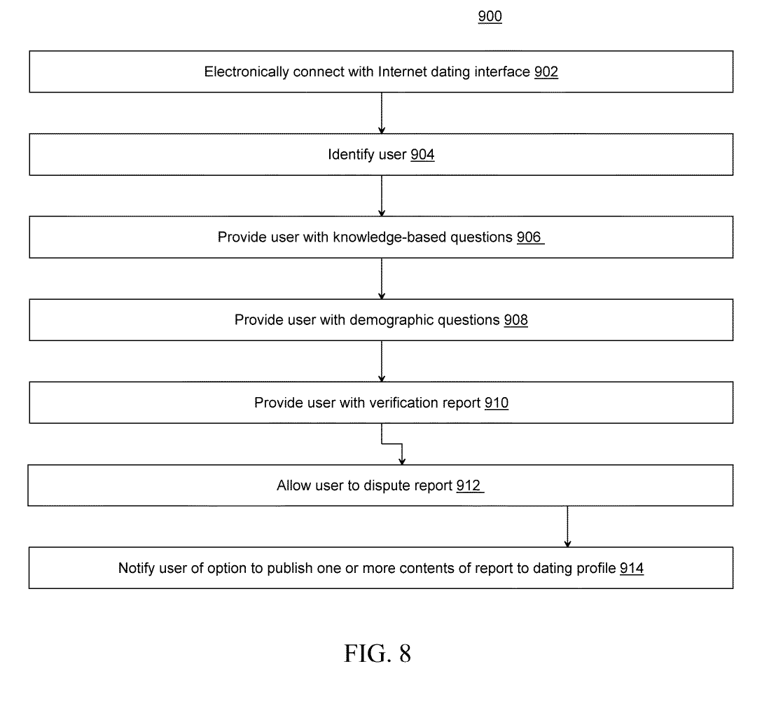

As described earlier, in some embodiments, information can be received by or provided by a user through a presentation interface. The client modules 104 and 106 (each having presentation interfaces 104a, 106a respectively) can communicate with server 102 through the network communication interface 108. Further, in some embodiments, the user can use a client 352, 354 (each having presentation interfaces 352a, 354a) respectively to access server system 300 through a network 350. FIG. 8 is an example block diagram 900 that includes steps that can be channeled through any of the presentation interfaces 104a, 106a, 352a, 354a. For example, in a first step 902, systems 100, 300 can be configured to electronically couple with the internet dating interface. In some embodiments, the system 100, 300 can be configured to identify the user (i.e., via a log in screen or the like) in a subsequent step 904. In some embodiments, the system 100, 300 can be configured to provide the user with knowledge-based questions. Thereafter, in step 908, the system 100, 300 can be configured to provide the user with demographic questions (i.e., present employment, education, and the like). It is to be understood however, that in some embodiments, step 908 can be omitted. In some further embodiments, the system 100, 300 can be configured to provide the user with a user verification report (step 910). In some embodiments, the system 100, 300 can be configured to allow the user to dispute one or more aspects of the report (step 912). In some embodiments, if the user does not choose to dispute the report, then the user can be notified of the option to publish one or more aspects of the report (step 914).

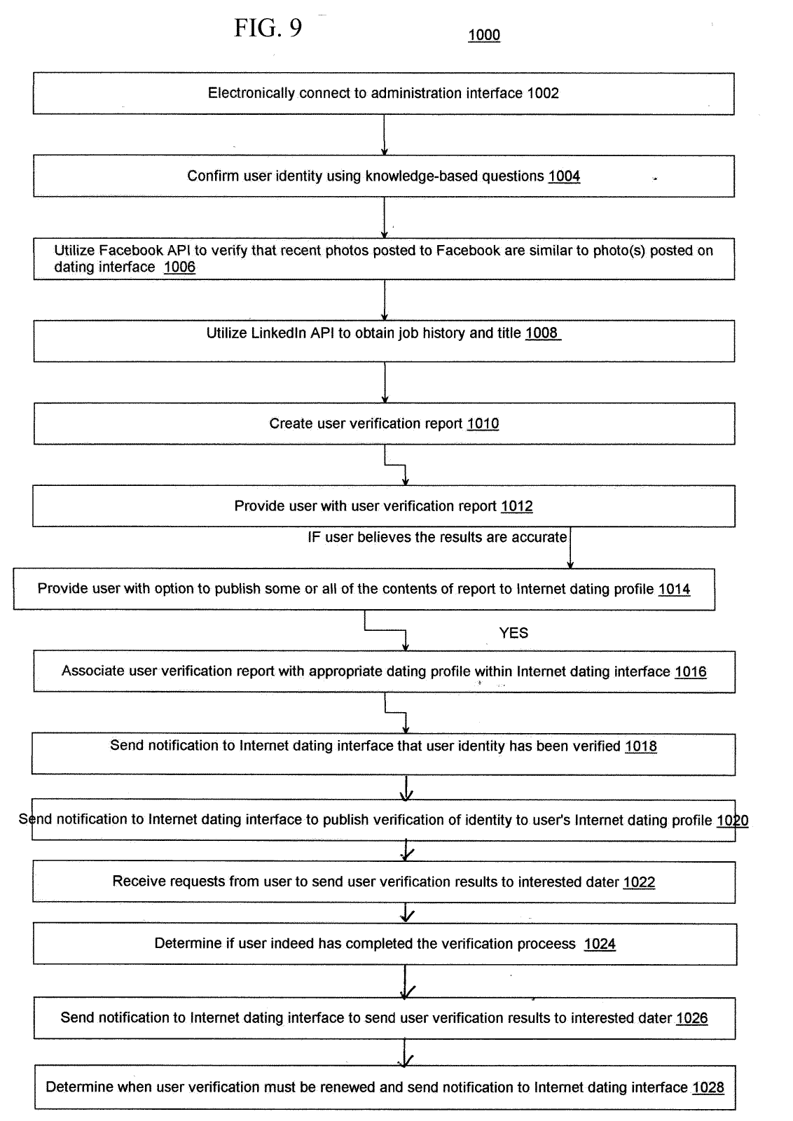

FIG. 9 is an example block diagram of a series of steps comprising a system 1000 that can be configured to run within a computer system (e.g., by computer system 200 within system 100 through administrative interface 102a). In some embodiments, in the first step 1002, the system 1000 can be configured to electronically couple with the administrative interface 102a. In this instance, in some embodiments, the system 1000 does not need to electronically couple with the dating interface. In some embodiments, the system 1000 can be configured to confirm user identity using knowledge-based questions in step 1004. In some further embodiments, the system 1000 can be configured to confirm user identity using information from a third party and/or a third party can confirm the user identity. In some embodiments, the system 1000 can be configured to verify/determine if the user's recent photos posted on Facebook® are similar to those posted on the dating website (step 1006). In some embodiments, this procedure can be used to determine whether the photos posted to the dating website are recent photos. In this instance, if the user consents, the system 1000 can be configured to post to the user's wall to request photos and/or to automatically obtain photos from Facebook® if the user consents. Facebook® is a registered trademark of Facebook, Inc.

In some embodiments, in a step 1008, the system 1000 can be configured to utilize a LinkedIn® API to obtain job history and/or a current job title. LinkedIn® is a registered trademark of LinkedIn Corp. Additionally, in some embodiments, the system 1000 can be configured to crawl other websites (e.g., such as other social media websites) to obtain additional information about the user. Thereafter, in some embodiments, the system 1000 can be configured to create a report such as a user verification report (in step 1010). In some embodiments, the system 1000 can ask the user which type of reports he or she is interested in. In some further embodiments, the types of reports include, but are not limited to, a generic report that does not show any information other than that the user has been validated. In some other embodiments, the report can comprise a standard report in which the user can be able to pick and choose what information to display, and the information that the user does not want displayed can just be redacted or left blank. In some further embodiments, the type of report can include a customized report wherein the user is allowed to pick and choose what he or she wants displayed within the report. In some embodiments, the report can be delivered to the user electronically. In some embodiments, the cost of the report can depend on the type of report, and/or the number of times it is requested and/or used by a dating website and/or a nanny website, or the like.

In some embodiments, the user can be provided with the option to publish results to his or her dating profile (step 1014). In some embodiments, if the user approves, the system 1000 can associate the user verification report with appropriate dating profile within the internet dating interface (step 1016). In some embodiments, the system 1000 can send a notification to the internet dating service that the user has been verified (step 1018). Further, in step 1020, the system 1000 can send a notification to the internet dating interface to publish verification of identity to the user's internet dating profile. In some embodiments of the invention, the system 1000 can receive requests from a user to send user verification results to an interested dater (step 1022). In some embodiments, the system 1000 can determine if the user has completed the verification process 1024. Further, in some embodiments, the system can send notification to the internet dating interface to send user verification results to an interested dater (step 1026). In some other embodiments, if the user does not approve of publishing some or all of the contents of the report to the internet dating interface, the report can be provided to the user so that he or she can use it at a later date. In these embodiments, the report cannot be associated with the dating profile. Further, in step 1028, the system 1000 can determine when the user verification must be renewed, and can send a communication to the internet dating interface regarding renewal.

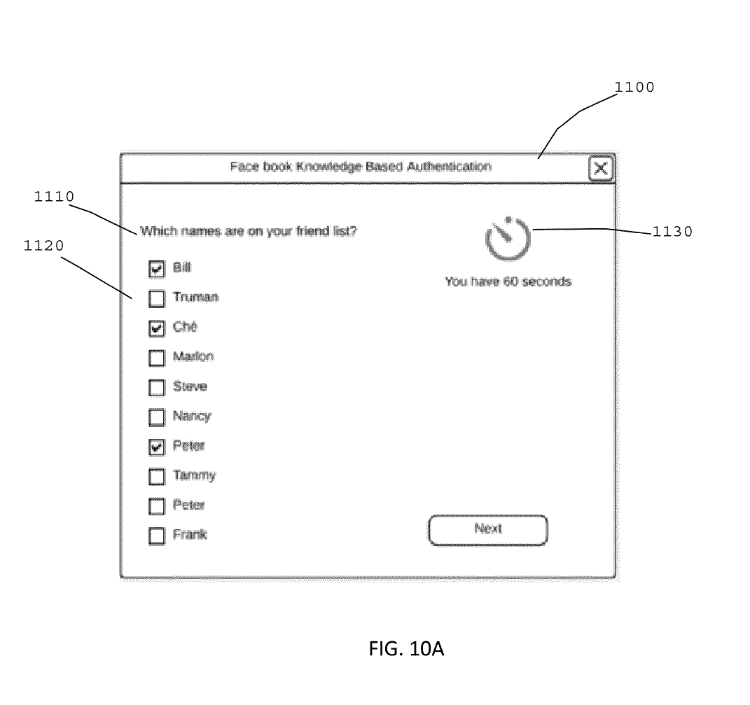

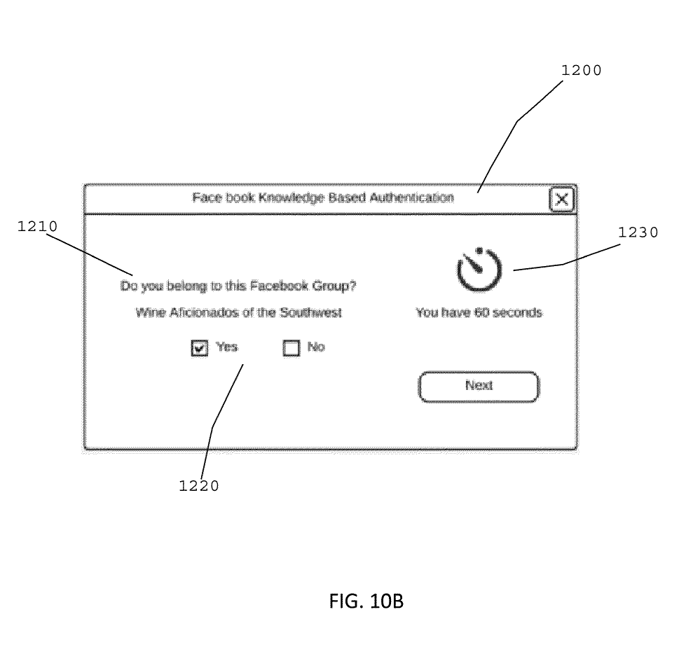

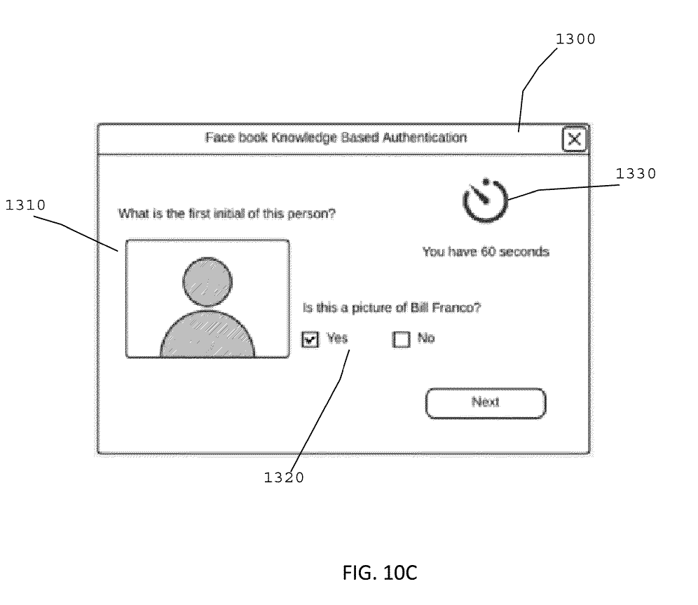

In some embodiments, in order to confirm the user's identity, one or more knowledge-based authentication windows can be displayed to the user. In some embodiments, at least one of the knowledge-based authentication windows can comprise a timed question and answer session. For example, FIGS. 10A-10C illustrate examples of knowledge-based authentication windows used to verify the identity of the Internet user in accordance with some embodiments of the invention. Specifically, FIG. 10A shows a knowledge-based authentication window 1100 that includes a user question 1110, and a plurality of answers 1120. In some embodiments, the system 100 can display a knowledge-based authentication window 1100 to a user with a user question 1110 with a time-response period. In some embodiments, the question 1110 can comprise a question of which names of friends are on the user's list. For example, in some embodiments, following a display of the question 1110, a timer icon 1130 can be displayed alerting the user to a specified period of time to answer. In some embodiments, if the user selects an answer from the plurality of answers 1120 (e.g., by selecting one or more friend names) within a time period indicated by the timer icon 1130, the user can be verified by the system 100. In some embodiments, if a user does not select an answer from the plurality of answers 1120 within a time period indicated by the timer icon 1130, the user may not be verified by the system 100. In other embodiments, the user can be presented with another question 1110 and plurality of answers 1120.

FIG. 10B illustrates a knowledge-based authentication window used to verify the identity of the Internet user in accordance with some embodiments of the invention. In some embodiments, the system 100 can display a knowledge-based authentication window 1200 to a user with a user question 1210 with a time-response period. For example, in some embodiments, following a display of the question 1210, a timer icon 1230 can be displayed alerting the user to a specified period of time to answer. In some embodiments, the question can comprise asking the user if the user belongs to a social media group (e.g., such as Facebook®). In some embodiments, if the user selects an answer from the plurality of answers 1220 within a time period indicated by the timer icon 1230, the user can be verified by the system 100. In some embodiments, if a user does not select an answer from the plurality of answers 1220 within a time period indicated by the timer icon 1230, the user may not be verified by the system 100. In other embodiments, the user can be presented with another question 1210 and plurality of answers 1220.

FIG. 10C illustrates a knowledge-based authentication window used to verify the identity of the Internet user in accordance with some embodiments of the invention. In some embodiments, the system 100 can display a knowledge-based authentication window 1300 to a user with a user question 1310 with a time-response period. For example, in some embodiments, following a display of the question 1310, a timer icon 1330 can be displayed alerting the user to a specified period of time to answer. In some embodiments, the question 1310 can comprise a photograph of a person and the user can be asked one or more questions. The questions can include “what is the first initial of this person” and/or “is this the picture of (name)”. In some embodiments, if the user selects an answer from the plurality of answers 1320 within a time period indicated by the timer icon 1330, the user can be verified by the system 100. In some embodiments, if a user does not select an answer from the plurality of answers 1320 within a time period indicated by the timer icon 1130, the user may not be verified by the system 100. In other embodiments, the user can be presented with another question 1310 and plurality of answers 1320.

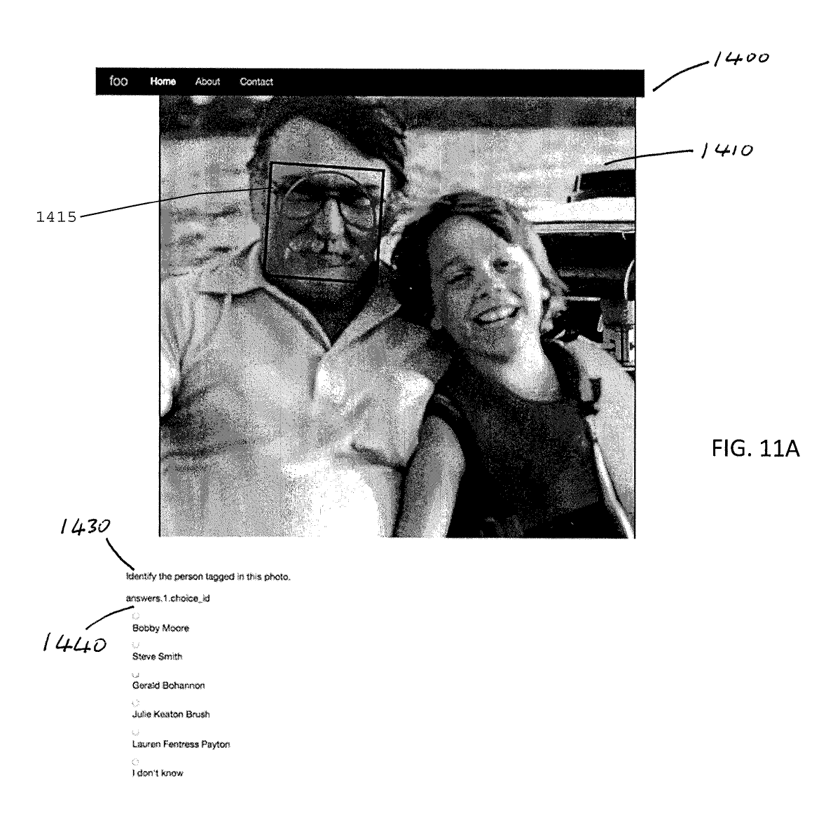

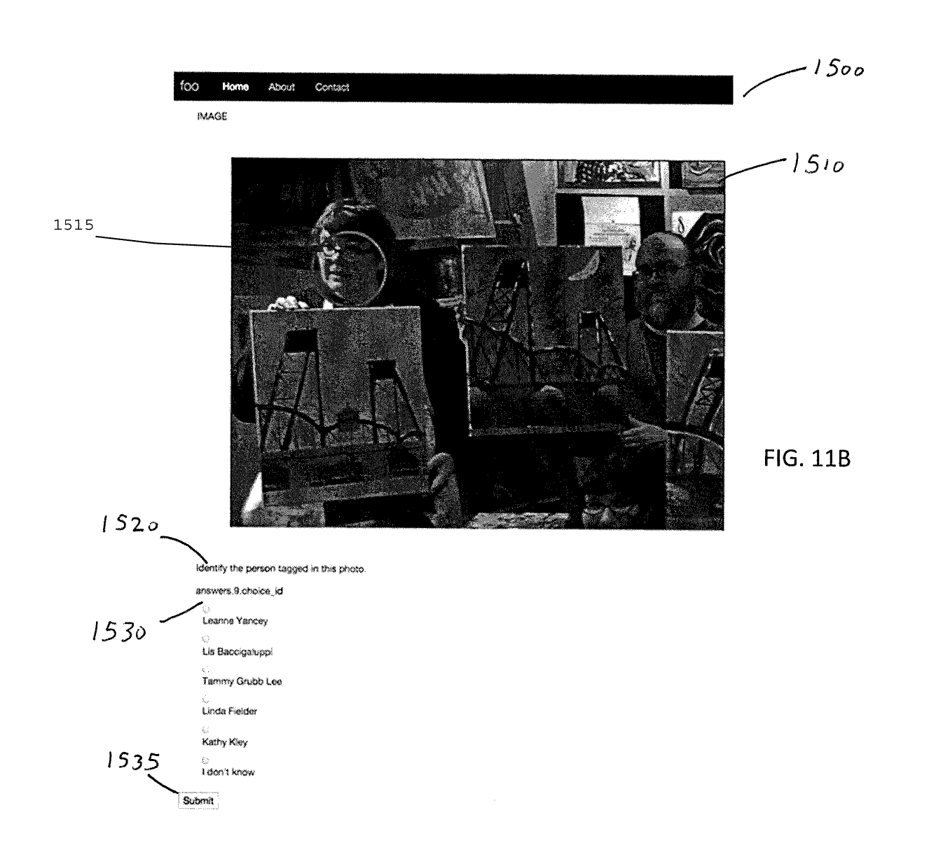

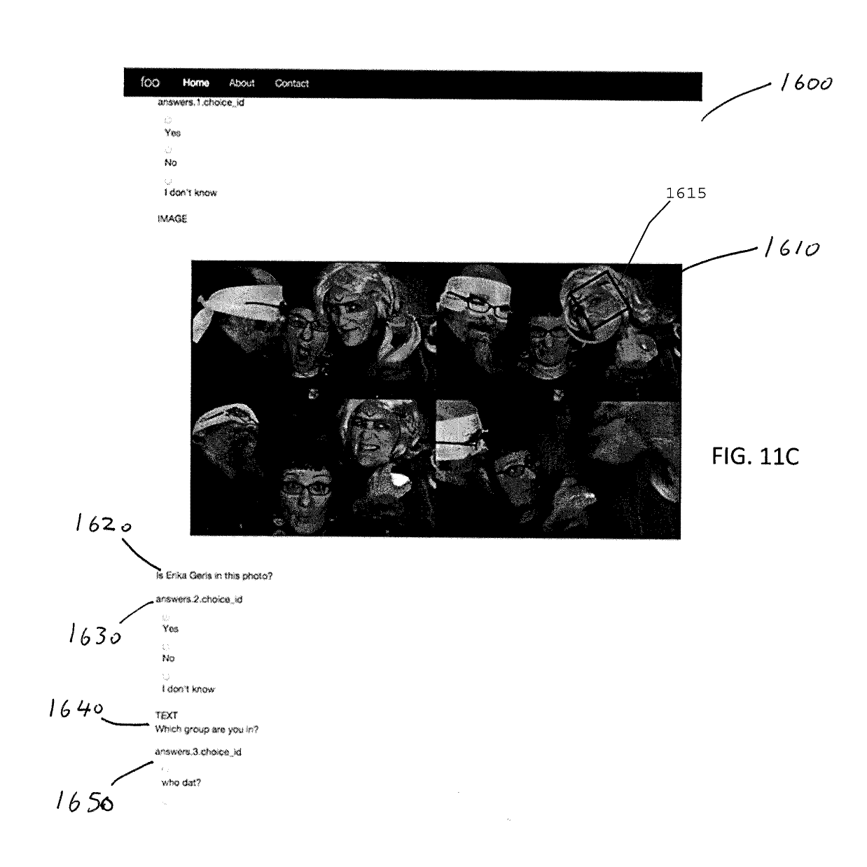

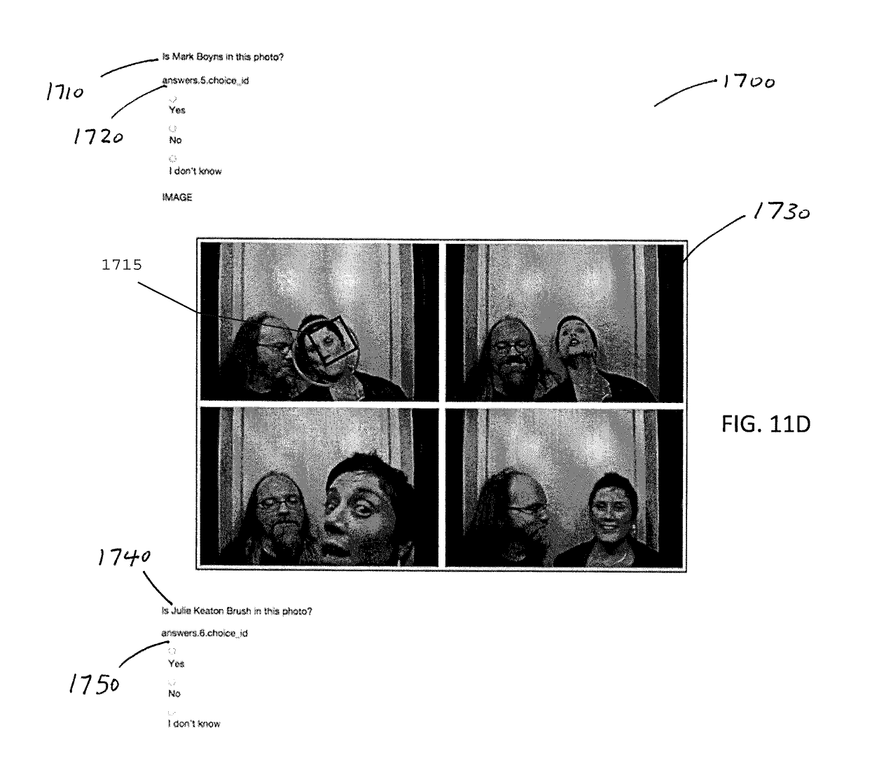

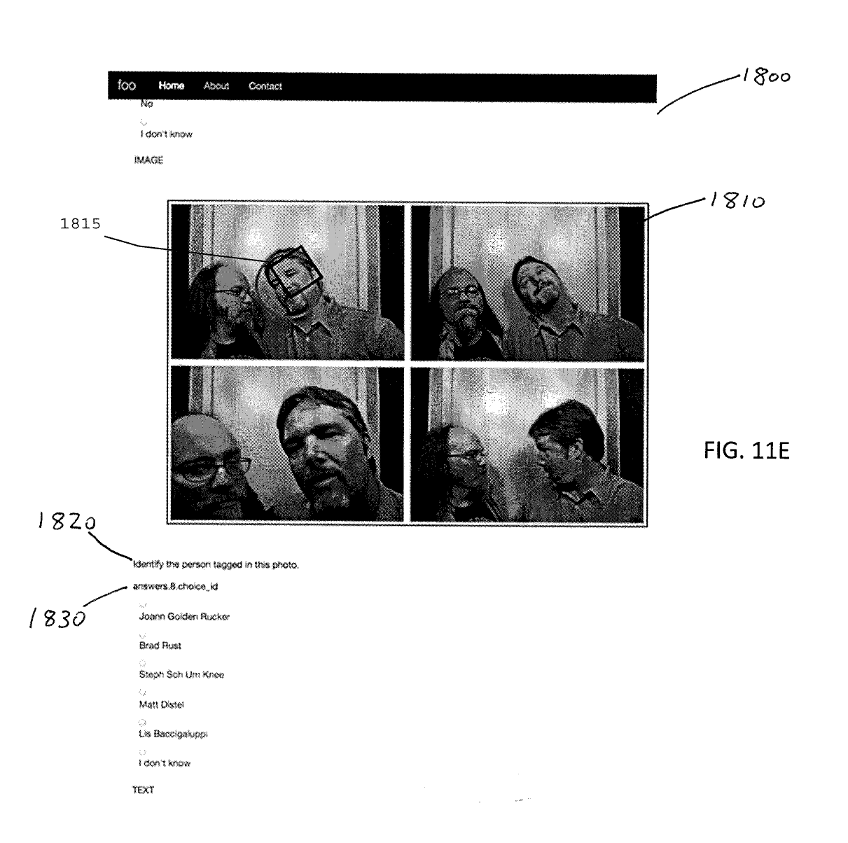

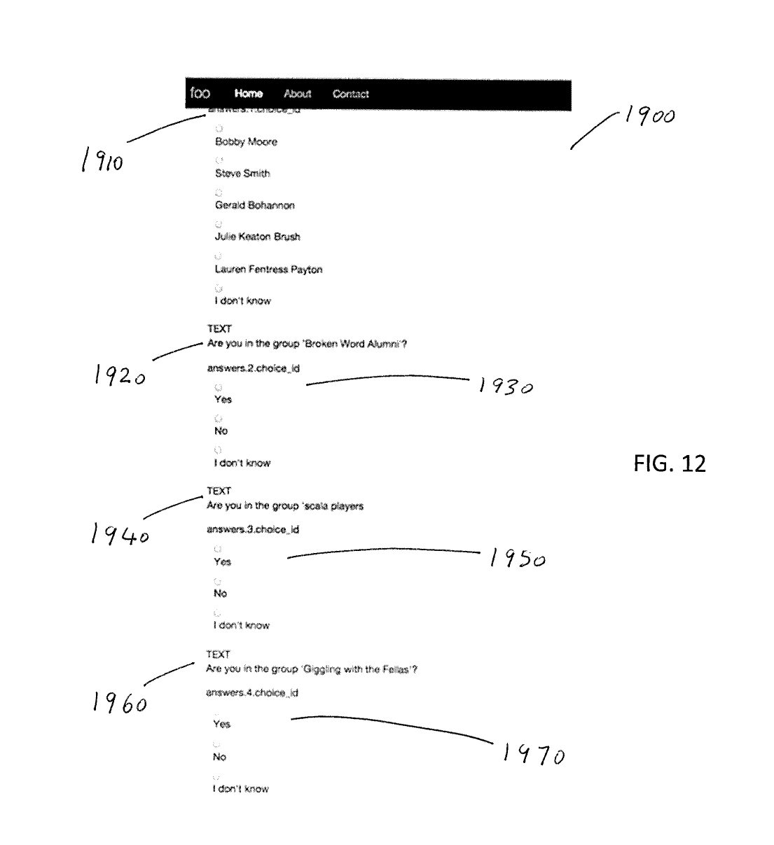

Further example embodiments of knowledge-based authentication are shown in FIGS. 11A-11E and FIG. 12. For example, FIG. 11A illustrates a knowledge-based authentication window 1400 used to verify the identity of the Internet user in accordance with some embodiments of the invention. In some embodiments, the system 100 can display a knowledge-based authentication window 1400 that can comprise at least one photograph or image 1410 of at least one person. The knowledge-based authentication window 1400 can also include one or more questions related to the name and/or identity of one or more persons in the at least one photograph or image 1410 of at least one person. For example, in some embodiments, the knowledge-based authentication window 1400 can request the identity of a person 1430 in the photograph or image 1410. In some embodiments, the photograph or image 1410 can include one or more tags 1415 marking or otherwise selecting a person in the photograph or image 1410. Further, the photograph or image 1410 can include a display of selectable answers 1440 related to the request of the identity of a person 1430. In some embodiments, the system 100 can enable a user to review the request the photograph or image 1410, and select at least one answer from the display of selectable answers 1440.

FIG. 11B illustrates a knowledge-based authentication window 1500 used to verify the identity of the Internet user in accordance with some embodiments of the invention. In some embodiments, the system 100 can display a knowledge-based authentication window 1500 that can comprise at least one photograph or image 1510 of at least one person. The knowledge-based authentication window 1500 can also include one or more questions related to the name and/or identity of one or more persons in the at least one photograph or image 1510 of at least one person. For example, in some embodiments, the knowledge-based authentication window 1500 can request the identity of a person 1520 in the photograph or image 1510. In some embodiments, the photograph or image 1510 can include one or more tags 1515 marking or otherwise selecting a person in the photograph or image 1510. Further, the photograph or image 1510 can include a display of selectable answers 1530 related to the request of the identity of a person 1520. In some embodiments, the system 100 can enable a user to select at least one answer from the display of selectable answers 1530 and submit the selected answer using a submit icon 1535.

FIG. 11C illustrates a knowledge-based authentication window 1600 used to verify the identity of the Internet user in accordance with some embodiments of the invention. In some embodiments, the system 100 can display a knowledge-based authentication window 1600 that can comprise at least one photograph or image 1610 of at least one person. The knowledge-based authentication window 1600 can also include one or more questions related to the name and/or specific identity of one or more persons in the at least one photograph or image 1610 of at least one person. For example, in some embodiments, the knowledge-based authentication window 1600 can request the identity of a specific person 1620 in the photograph or image 1610. In some embodiments, the photograph or image 1610 can include one or more tags 1615 marking or otherwise selecting a person in the photograph or image 1610. Further, the photograph or image 1610 can include a display of selectable answers 1630 related to the request of the identity of a specific person 1620, and can enable a user to select at least one answer from a display of selectable answers 1630. In some embodiments, the selectable answers can comprise a “yes” or “no” answer related to the identity of a specific person 1620. In some embodiments, the knowledge-based authentication window 1600 can include additional questions 1640 and associated answers 1650.

FIG. 11D illustrates a knowledge-based authentication window used to verify the identity of the internet user in accordance with some embodiments of the invention. In some embodiments, the system 100 can display a knowledge-based authentication window 1700 that can comprise at least one photograph or image 1730 of a plurality of persons. The knowledge-based authentication window 1700 can also include one or more questions related to the name and/or specific identity of the persons in the at least one photograph or image 1730. For example, in some embodiments, the knowledge-based authentication window 1700 can request the identity of at least one specific person in the photograph or image 1730. As shown in the example embodiments, the knowledge-based authentication window 1700 can include the request of the identity of a specific person 1710 with selectable answers 1720, and the request of the identity of a specific person 1740 with selectable answers 1750. In some embodiments, the photograph or image 1730 can include one or more tags 1715 marking or otherwise selecting a person in the photograph or image 1730. In some embodiments, the selectable answers 1720, 1750 can comprise a “yes” or “no” answer related to the identity of persons in the photograph or image 1730.

FIG. 11E illustrates a knowledge-based authentication window 1800 used to verify the identity of the internet user in accordance with some embodiments of the invention. In some embodiments, the system 100 can display a knowledge-based authentication window 1800 that can comprise at least one photograph or image 1810 of at least one person. The knowledge-based authentication window 1800 can also include one or more questions related to the name and/or identity of persons in the at least one photograph or image 1810. For example, in some embodiments, the knowledge-based authentication window 1800 can request the identity of a tagged or marked person 1820 in the photograph or image 1810. In some embodiments, the photograph or image 1810 can include one or more tags 1815 marking or otherwise selecting a person in the photograph or image 1810. In some embodiments, the system 100 can enable a user to select an answer from the display of selectable answers 1830.

FIG. 12 illustrates a knowledge-based authentication window 1900 used to verify the identity of the internet user in accordance with some embodiments of the invention. In some embodiments, the knowledge-based authentication window 1900 can include a plurality of questions and associated answers. In some embodiments, the knowledge-based authentication window 1900 can display a scrollable list of questions and associated answers. For example, in some embodiments, the knowledge-based authentication window 1900 can comprise answers 1910 including specific names and additional questions 1920, 1940, 1960 with associated answers 1930, 1950, 1970. In some embodiments, the questions and answer can be display adjacent to each other within the knowledge-based authentication window 1900. In other embodiments, a user can scroll the knowledge-based authentication window 1900 to view various questions and associated answers related to knowledge-based authentication.

Some embodiments of the invention also relate to a device or an apparatus for performing these operations. In some embodiments, the apparatus can be specially constructed for the required purpose, such as a special purpose computer. In some embodiments, when defined as a special purpose computer, the computer can also perform other processing, program execution or routines that are not part of the special purpose, while still being capable of operating for the special purpose. Alternatively, in some other embodiments, the operations can be processed by a general purpose computer selectively activated or configured by one or more computer programs stored in the computer memory, cache, or obtained over a network. Some embodiments include instances when data are obtained over a network, and where the data can be processed by other computers on the network, e.g. a cloud of computing resources.

With the above embodiments in mind, it should be understood that some embodiments of the invention can employ various computer-implemented operations involving data stored in computer systems. Moreover, in some embodiments, the above-described databases and models throughout the system can store analytical models and other data on computer-readable storage media. In addition, in some embodiments, the above-described applications of the monitoring system can be stored on computer-readable storage media. These operations are those requiring physical manipulation of physical quantities. Usually, though not necessarily, these quantities take the form of electrical, electromagnetic, or magnetic signals, optical or magneto-optical form capable of being stored, transferred, combined, compared and otherwise manipulated.

In some embodiments, the invention can also be embodied as computer readable code on a computer readable medium. Some embodiments include a computer readable medium that can be any data storage device that can store data, which can thereafter be read by a computer system (e.g., such as mass storage device 207 shown in FIG. 2). Examples of the computer readable medium can include hard drives, network attached storage (NAS), read-only memory, random-access memory, FLASH based memory, CD-ROMs, CD-Rs, CD-RWs, DVDs, magnetic tapes, other optical and non-optical data storage devices, or any other physical or material medium which can be used to tangibly store the desired information or data or instructions and which can be accessed by a computer or processor.

In some embodiments, the computer readable medium can also be distributed over a conventional computer network via the network interface so that the computer readable code can be stored and executed in a distributed fashion. For example, in some embodiments, one or more components of the system architecture can be tethered to send and/or receive data through a local area network (“LAN”). In some further embodiments, one or more components of the system architecture can be tethered to send or receive data through an internet (e.g., a wireless internet). In some embodiments, at least one software application running on at least one processor can be configured to be coupled for communication over a network.

In some embodiments, one or more components of the network can include one or more resources for data storage, including any other form of computer readable media beyond the media for storing information and including any form of computer readable media for communicating information from one electronic device to another electronic device. Also, in some embodiments, the network can include wide area networks (“WAN”), direct connections (e.g., through a universal serial bus port) or other forms of computer-readable media, or any combination thereof. Also, various other forms of computer-readable media can transmit or carry instructions to a computer, including a router, private or public network, or other transmission device or channel, both wired and wireless. In some embodiments, the software modules can be configured to send and receive data from a database (e.g., from a computer readable medium including data sources and data storage that can comprise a database), and data can be received by the software modules from at least one other source. In some embodiments, at least one of the software modules can be configured within the system to output data to a user via at least one digital display (e.g., to a computer comprising a digital display).

In some embodiments, one or more components of the network shown in FIG. 3 can include a number of client devices 352, 354 that can be personal computers including for example desktop computers, laptop computers, digital assistants, personal digital assistants, cellular phones, mobile phones, smart phones, pagers, digital tablets, internet appliances, and other processor-based devices. In general, a user device can be any type of external or internal devices such as a mouse, a CD-ROM, DVD, a keyboard, a display, or other input or output devices.

In some embodiments, the system architecture as described and illustrated in FIG. 3 can enable one or more users to receive, analyze, input, modify, create and send data to and from the system architecture, including to and from one or more enterprise applications running on the system architecture 30. Some embodiments include at least one user accessing one or more modules, including at least one enterprise applications via a stationary I/O device through a LAN. In some other embodiments, the system architecture can enable at least one user accessing enterprise applications via a stationary or mobile I/O device through an internet.

Any of the operations described herein that form part of the invention are useful machine operations. The invention also relates to a device or an apparatus for performing these operations. Some embodiments of the invention can be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage generally or in particular formats that enable the construction or depiction of a physical and tangible object. In some embodiments, the manipulation can be performed by a processor. In such an example, the processor thus transforms the data from one thing to another. Still further, the methods can be processed by one or more machines or processors that can be coupled via at least one network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

In some embodiments, the above mentioned apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general purpose computer selectively activated or configured by one or more computer programs stored in the computer memory, cache, or obtained over a network. When data is obtained over a network the data can be processed by other computers on the network, e.g. a cloud of computing resources

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. An online profile system for a user comprising:
at least one processor configured to couple to at least one server and at least one non-transitory computer-readable storage medium for tangibly storing information related to a user account, the non-transitory computer-readable storage medium including program logic related to building and accessing at least one online profile which when executed by the processor, can perform steps comprising:
using the at least one processor to process a verification of a first user;
receiving from the first user a user verification report distribution instruction based on the first user's judgment of the accuracy of the user verification report; and
wherein based on the first user's judgment comprising an accurate judgment, the processor is configured to process steps:
i). associate at least a portion of the first user's verification report with a first user's internet service profile within the internet service interface;
ii). send a user verification notification to the internet service interface that the first user has been verified;
iii). send a notification to the internet service interface to publish verification of identity to the first user's internet service profile;
iv). receive requests from the first user to send user verification results to a second user;
v). determine if the first user has completed verification processes;
vi). send notification to the internet service interface to send the first user verification report to the second user; and
wherein based on the at least one user's judgment comprising an inaccurate judgment, the processor is configured to:
provide the first user with an option to dispute at least a portion of the first user's verification report;
receiving and processing dispute information from the first user;
initiating a secondary search of the first user;
processing a determination of the accuracy of the inaccurate judgment;
notifying the first user of results of the secondary search; and
processing steps (i) to (vi) based at least in part on the first user's agreement to publish the first user's verification report.

2. The system of claim 1, wherein based on the first user's judgment comprising an accurate or inaccurate judgment, the processor is further configured to determine a renewal date of first user verification and send notification of the renewal date to the internet service interface.

3. The system of claim 1, wherein the verification of the first user comprises:
performing a login process of the first user;
using the at least one processor to electronically couple to an internet service interface;
providing a user verification process initiation tool wherein upon a first user selection of the tool the at least one processor is configured to perform a user verification of the first user comprising the steps of:
receiving and processing by the at least one processor at least one verification question and creating at least one user verification report at least partially based on the at least one verification question; and
providing the at least one user verification report to the first user.

4. The system of claim 3, wherein the user verification process initiation tool comprises an upsell offer.

5. The system of claim 3, wherein the at least one verification question comprises at least one knowledge-based question and at least one demographic question.

6. The system of claim 5, wherein responses from the at least one knowledge-based question are at least partially processed by the at least one processor to determine accuracy.

7. The system of claim 5, wherein responses from the at least one demographic question are at least partially processed by the at least one processor to determine accuracy.

8. The system of claim 5, wherein responses from the at least one knowledge-based question are at least partially processed by a third party to determine accuracy.

9. The system of claim 5, wherein responses from the at least one demographic question are at least partially processed by a third party to determine accuracy.

10. The system of claim 1, wherein the internet service interface comprises an internet dating service.

11. The system of claim 1, wherein the verification of the first user comprises:
performing a login process of an administrator;
using the at least one processor to electronically couple to an administrator interface;
providing a user verification process initiation tool wherein upon the administrator selection of the tool the at least one processor is configured to perform a user verification of a first user comprising the steps of:
confirming first user identity using at least one knowledge-based question;
using a programming interface of a first social media application to verify a first type of personal first user information posted to the first social media application;
using a programming interface of a second social media application to verify a second type of personal first user information posted to the second social media application; and
providing the at least one user verification report to the first user.

12. The system of claim 11, wherein the at least one social media application is Facebook® and the first type of personal first user information comprises at least one photo of the first user.

13. The system of claim 11, wherein the at least one social media application is LinkedIn® and the second type of personal first user information comprises a first user's job history and title.

14. An online profile system for a user comprising:
at least one processor configured to couple to at least one server and at least one non-transitory computer-readable storage medium for tangibly storing information related to a user account, the non-transitory computer-readable storage medium including program logic related to building and accessing at least one online profile which when executed by the processor, can perform the steps comprising:
using the at least one processor to process a verification of a first user;
receiving a first user verification report distribution instruction;
associate at least a portion of the first user's verification report with a first user's internet service profile within the internet service interface;
send a user verification notification to the internet service interface that the first user has been verified;
send a notification to the internet service interface to publish verification of identity to the first user's internet service profile;
receive requests from the first user to send user verification results to a second user;
determine if the first user has completed verification processes;
send notification to the internet service interface to send the first user verification report to the second user; and
determine a renewal date of first user verification and send notification of the renewal date to the internet service interface.

15. The system of claim 14, wherein the verification of the first user comprises:
performing a login process;
using the at least one processor to electronically couple to an internet service interface;
providing a first user verification process initiation tool wherein upon a user selection of the tool the at least one processor is configured to perform a verification of the first user comprising the steps of:
receiving and processing by the at least one processor at least one verification question and creating at least one first user verification report at least partially based on the at least one verification question,
the at least one verification question comprising at least one knowledge-based question and at least one demographic question; and
providing the at least one user verification report to the user.

16. The system of claim 15, wherein the first user verification report distribution instruction is received from the first user.

17. The system of claim 15, wherein the first user verification report distribution instruction is received from an administrator.

18. The system of claim 16, wherein responses from at least one of the at least one verification question are at least partially processed by the at least one processor to determine accuracy.

19. The system of claim 16, wherein responses from at least one of the at least one verification question are at least partially processed by a third party to determine accuracy.

20. The system of claim 14, further comprising using the at least one processor to perform the steps of:
flagging a user account of the first user upon receipt of a notification from the internet service interface that the user has a deactivated profile, the deactivated profile comprising at least one of an instance comprising the first user performing a profile deactivation, the first user performing a hide profile action, an administrator performing a profile deactivation, the at least one processor performing a profile deactivation based on notification from the internet service interface; and
sending a notification to at least one of the first user, the internet service profile, and an administrator that the first user verification must be renewed.

21. The system of claim 14, further comprising using the at least one processor to perform the steps of:
storing dates related to the verification of the first user including at least one of the date of initiation of the verification of the first user and the date the verification report was created;
send notification of renewal of the verification of the first user to at least one of the user, the first user, and the internet service interface;
flag the verification of the first user as expired; and
performing a verification of the first user based at least in part on receiving a request to renew the verification report within a specified time period.

22. The system of claim 14, wherein the internet service interface comprises an internet dating service.

23. The system of claim 5, wherein responses from the at least one knowledge-based question are timed.

24. The system of claim 15, wherein responses from the at least one knowledge-based question are timed.

25. An online profile system for a user comprising:
at least one processor configured to couple to at least one server and at least one non-transitory computer-readable storage medium for tangibly storing information related to a user account, the non-transitory computer-readable storage medium including program logic related to building and accessing at least one online profile which when executed by the processor, can perform the steps comprising:
using the at least one processor to process a verification of a first user, the verification of the first user comprising:
performing a login process;
using the at least one processor to electronically couple to an internet service interface;
providing a first user verification process initiation tool wherein upon a user selection of the tool the at least one processor is configured to perform a verification of the first user comprising the steps of:
receiving and processing by the at least one processor at least one verification question and creating at least one first user verification report at least partially based on the at least one verification question,
the at least one verification question comprising at least one knowledge-based question and at least one demographic question; and
wherein responses from the at least one knowledge-based question are timed; and
providing the at least one user verification report to the user;
receiving a first user verification report distribution instruction;
associate at least a portion of the first user's verification report with a first user's internet service profile within the internet service interface;
send a user verification notification to the internet service interface that the first user has been verified;
send a notification to the internet service interface to publish verification of identity to the first user's internet service profile;
receive requests from the first user to send user verification results to a second user;
determine if the first user has completed verification processes;
send notification to the internet service interface to send the first user verification report to the second user.
